(19) United States
(12) Patent Application Publication
(10) Pub. No.: US 2003/0126962 A1
(43) Pub. Date: Jul. 10, 2003

(54) Digital photofinishing mehtod and apparatus

(76) Inventors: William E. Bland, Cardiff-by-the-Sea, CA (US); Terence Chee Sung Chang, Poway, CA (US); Marland Chow, San Diego, CA (US); David Clark, Poway, CA (US); Michael H. Davis, Ramona, CA (US); Scott Matthew Dennis, San Diego, CA (US); Sergio Escobedo, San Diego, CA (US); David Wayne Jasinski, San Diego, CA (US); Daniel Steven Kline, Encinitas, CA (US); John F. Manard JR., San Diego, CA (US); James Mason, Webster, NY (US); Kerry Neal McKay, San Diego, CA (US); David B. Petch, La Jolla, CA (US); David Michael Petersen, Escondido, CA (US); Michael Puyot, Escondido, CA (US); Rajan Ramaswamy, San Diego, CA (US); Robert John Rosati, Carlsbad, CA (US); Herb Sarnoff, Escondido, CA (US); James Robert Schmedake, San Diego, CA (US); Honsheng Zhang, San Diego, CA (US); Mark Steven Janosky, Rochester, NY (US); James Arthur Larrabee, Rochester, NY (US); Stephan Paul Lolacona, Hilton, NY (US)

Correspondence Address: Stephen B. Salai, Esq., Harter, Secrest & Emery LLP, 1600 Bausch & Lomb Place, Rochester, NY, 14604-2711, US

(21) Appl. No.: 10/062,947

(22) Filed: Feb. 2, 2002

Related U.S. Application Data
(60) Provisional application No. 60/345,463, filed on Jan. 4, 2002.
(60) Provisional application No. 60/349,386, filed on Jan. 18, 2002.

(51) Int. Cl. B26D 1/00

(52) U.S. Cl. 83/13; 83/948

(57) ABSTRACT

A photofinishing system and method for providing for the digital processing of a set of photographs including a digital printer, buffer, laminator and cutter, and associated methods of use for improving the accuracy of printing, processing, laminating and cutting individual photos during a digital photofinishing process.

### CROSS REFERENCE TO RELATED APPLICATIONS

The subject application is related to an application entitled “Method of Utilizing Wasted Nested Space” Ser. No. 10/001,642 filed Oct. 31, 2001; and to an application entitled “Cutter System for Multi-Size Photographic Prints” Ser. No. 09/995,092 filed Nov. 27, 2001; and to an application entitled “Printed Medium with Integral Image Locator and Method” Ser. No. 10/020,397 filed Dec. 12, 2001; and to an application entitled “Transport Buffer Having Force Limiting Drive Means and Method” Ser. No. 10/034,183 filed Dec. 28, 2001; and to an application entitled “Method of Exercising Nozzles of an Inkjet Printer and Article” Ser. No. 10/032,919 filed Dec. 28, 2001; and to an application entitled “Method for Judging Image Quality Using Human-Readable Defect-Sensitive Patterns” Ser. No. 10/032,920 filed Dec. 28, 2001; and to an application entitled “Laminate Cartridge” Ser. No. 10/038,743 filed Dec. 31, 2001; and to an application entitled “Overcoat Application Peel Apparatus” Ser. No. 10/038,792 filed Dec. 31, 2001; and to an application entitled “Image Quality and Permanence of Prints From an Inkjet Digital Photofinishing System” Serial No. 60/345,463 filed Jan. 4, 2002; and to an application entitled “Processing Film with Digital Minilabs” Ser. No. ______ filed Jan. 18, 2002; and to an application entitled “Buffer with Service Loop and Method” Ser. No. ______ filed Feb. 1, 2002; and to an application entitled “Method and Apparatus for Applying a Matte Finish to Photographs” Ser. No. ______ filed Feb. 2, 2002.

### TECHNICAL FIELD

The present invention relates generally to an apparatus and a method for digital photofinishing to be used in a film processing operation to produce a printed medium such as a sheet of photographs that is subsequently cut into individual photos. More particularly the invention relates to a digital printer, buffer, laminator and cutter, and associated methods of use for improving the accuracy of printing, processing, laminating and cutting individual photos during a digital photofinishing process.

### BACKGROUND OF THE INVENTION

In photofinishing operations it is conventional to develop and print photographs on roll stock photographic paper having a width that generally accommodates one size of print. After printing out a roll of photos on a piece of the roll stock, the printed piece is cut to provide the individual prints each cut severing one of the prints from the strip. Dedicating a given width of roll stock to the production of a given size photo is less flexible for fulfilling print orders and slows throughput. It requires the photofinishing operation either to have multiple machines, each dedicated to a given size of photo or it places a burden on the operator to change the print media from one size to another after completing orders.

Advancements in photofinishing allow for the production of photographs by ink jet printers, laser printers and other photofinishing printer systems not dependent upon traditional wet chemistry as well as other photofinishing printers including silver-halide systems that receive digital input and employ conventional wet chemistry output. Such printers for example produce the image from a digital memory. Moreover, the use of computers in connection with these advancements allows for further improvement. For example, with a computer controlled printer it is not necessary to use roll stock having the width of a desired finished photo. A photofinishing printer now can generate photos of various sizes on a single sheet of print media. Also the images can be manipulated to arrange multiple images on a single larger sheet. The single sheet then can be cut longitudinally and transversely to separate the individual photographs.

Durability of photographic and near photographic images has become a feature that has grown in demand in recent years. Current commercial means of improving durability include lamination with a clear adhesive liquid laminate material or coating (via spray or liquid application) with a liquid that dries to a clear protective layer. Another lamination process known as “peel apart” lamination has been demonstrated for diffusion transfer images.

One particular type of “peel apart” lamination is a peel-apart thermal transfer lamination process. This technique transfers an overcoat material from a donor support to a printed image. This transfer is often done through a process in which the donor support with the overcoat and the printed media are brought together mechanically with pressure and then heat is applied for a specific exposure time period. These lamination mechanisms can be expensive, and difficult to put and keep in position. In addition the prior art devices are not efficient causing lost hours and additional costs due to downtime. Finally many of these devices cause machine failures leading to expensive machine downtime and repairs. Therefore there is a need for an improved peeler device that is low cost and effective for a wide range of printing processes and peel-apart materials. The present invention includes intention a mechanism that meets these needs.

After printing and when cutting single images from a larger sheet there are several sources of errors such as offset errors that contribute to inaccuracies in making the several cuts necessary to produce the single image. For example, the printer can misalign the images on the larger sheet of print medium. Mechanism skew, drive roller tolerance, cutter positioning errors and resolution also contribute to cutting errors. To some extent over-printing the images to a size slightly larger than the finished photograph size can compensate for these errors. By over-printing, portions of the image can be removed during cutting without materially altering the image.

Photofinishing equipment, especially inkjet printers, laminators and cutters require periodic maintenance to insure print quality. For example: most inkjet print heads encounter several problems if left unused out in the atmosphere. Chemical components in the ink slowly evaporate from the exposed meniscus at each nozzle causing the ink to locally increase in viscosity, become increasingly concentrated with dye, or otherwise be inconsistent with the bulk ink properties. If left unchecked, the printing resulting from using these aged nozzles results in decreased image quality. To prevent these problems, new print heads are shipped with tape covering the nozzle plate that is removed when the print head is installed. During operation, a capping station within the printer seals the nozzle plate, preventing evaporation of the ink during periods of inactivity.

For these reasons it is desirable to provide for diagnostic testing of the photofinishing printer without undue interruption of the photofinishing operation. It is possible to utilize otherwise scrap portions of the print media for such testing.

Accordingly, an object of the present invention is to provide an efficient digital photofinishing method and apparatus.

Another object of the present invention is to provide a photofinishing method and apparatus for producing various size prints from a sheet of print media wherein waste space on the sheet resulting from the nesting of photographic images of various sizes on a single sheet is utilized for constructive purposes.

Another object is to provide a photofinishing operation in which otherwise wasted print media is used for diagnostic purposes or to produce an economic return

Another object of the present invention is to provide a method for simultaneously exercising the nozzles of an inkjet print head and printing fiducial marks on the print medium.

Still another object of the present invention is to provide an ink jet printed segment having a fiducial mark composed of the exercise of a nozzle associated with an image on the segment for identifying the location of one or more printed images on the sheet.

Still another object of the present invention is to provide an overcoat application process in which an overcoat material is transferred from a donor support to a printed image.

### SUMMARY OF THE INVENTION

In accordance with the method of the present invention, there is an apparatus and method for digital photofinishing. The apparatus including a printer having a printing width greater than twice the width of a first print size, and at least equal to the width of a second larger print size; a supply of continuous feed media; an image processor connected to the inkjet printer for digitizing images to be printed for one customer and arranging the digitized images for printing in at least a 2×2 matrix of prints of at least two different sizes; a cutter for cutting the continuous feed media into sheets, each sheet carrying the matrix of prints for one customer; and a two-axis cutter controlled by the image processor and cutting the sheets into individual prints of at least two different sizes. The apparatus also has a laminator disposed between the inkjet printer and the two-axis cutter for laminating the sheets with a protective film of material.

In the present invention the inkjet printer, laser printer or the like is used to print one or more photographs onto a larger sheet, preferably photographic paper. The photographs are generated from a digital file and a computer is programmed to array the images on the sheet to best utilize the space available. Where image size and number permit, the photographs can be arrayed in aligned transverse rows and aligned longitudinal columns. Preferably, the print sizes are selected and arranged on the sheet so that all the prints in any given row have aligned leading and trailing edges. The computer further generates fiducial marks relative to the array of images and these fiducial marks are printed together with the photographic images. Preferably, two fiducial marks are printed together with the images. A first fiducial mark extends across the leading edge of the sheet in advance of a first row of photographic images. A second fiducial mark is printed along a lateral edge of the sheet and orthogonal to the first fiducial mark so fiducial marks along two axes are formed.

In accordance with the method of the present invention, a set of photographs is processed by a photofinishing system, laminated and cut. This may include a customer order comprising photographs of a single size or of various sizes. In this respect the image data, including the number and size of prints desired as supplied by the customer is inputted into the system for processing. The data is communicated to the printing portion of the system, which includes a computer controlled photographic printer. The quantity of prints and the various sizes of prints to be made are analyzed by the computer software and based on this analysis, the most space efficient layout of the photographs is planned for the given width of print media that is being used. Included in the analysis for the most efficient layout of prints is a determination of the size and location of any waste space resulting from the planned printing layout.

### DESCRIPTION OF THE DRAWINGS

FIG. 1 is a schematic showing a photofinishing system according to the present invention;

FIG. 2 is a schematic representation showing a portion of the photofinishing system for the printing of photographic images;

FIG. 3 is a schematic representation showing a photofinishing operation for the printing of photographic images and fiducial marks on a print medium;

FIG. 4 illustrates a segment of print medium produced by the arrangement of FIG. 1;

FIG. 5 is similar to FIG. 4 only showing another embodiment of the segment;

FIG. 6A-D is a schematic representation showing steps in the cutting of the segment of FIG. 4 into separate photographs;

FIG. 7 is a view of a portion of the segment of FIG. 4 showing use of the fiducial marks to correct skew;

FIG. 8 is a view of a printed segment with fiducial marks for providing calibration correction;

FIG. 9 is mechanical schematic diagram of an overcoat application mechanism in accordance with the invention;

FIG. 10 is a detailed isometric view of a portion of the overcoat application peel apparatus;

FIG. 11 is a side view of a portion of the overcoat application peel apparatus showing the thermal system;

FIG. 12 is detailed isometric view of the overcoat application peel apparatus;

FIG. 13 is a view of the overcoat application peel apparatus;

FIG. 14 is a detailed isometric view of an overcoat application peel apparatus showing the flex spring;

FIG. 15 is a side view of the laminate cartridge of the present invention;

FIG. 16 is a perspective view of the laminate cartridge;

FIG. 17 is a portion of the laminate cartridge including the core;

FIG. 18 is another embodiment of the laminate cartridge showing a portion of the laminate cartridge including the core;

FIG. 19 is another embodiment of the laminate cartridge showing a portion of the laminate cartridge including the core;

FIG. 20 is a side view of the overcoat application apparatus including the laminate cartridge;

FIGS. 21-26 are schematic views showing steps in the operation of the buffer of the present invention;

FIG. 27 is a perspective view showing a driven roller mechanism as used in the buffer;

FIG. 28 is a block diagram showing the position of the buffer of the present invention;

FIG. 29 is a view in cross section showing laminated sheets prior to separation;

FIGS. 30-38 are views showing a portion of the buffer at successive operational steps;

FIG. 39 shows a sequence of steps for producing a inkjet printed photograph according to the present invention;

FIGS. 40 and 41 are schematic illustrations of the apparatus for embossing a laminated photographic image in different operative positions;

FIG. 42 is a view showing, in cross section, a portion of a matte finish photograph in accordance with the present invention;

FIGS. 43-48 are schematic plan views showing a transport table and steps in the cutting of individual prints from a single sheet containing a plurality of photographic prints;

FIG. 49 is a front elevation view, partly broken away and in section showing a cutter at the inlet end of a transport table;

FIG. 50 is an isometric view showing a portion of the cutter at the inlet end from a reverse angle;

FIG. 51 is a view taken along lines 9-9 of FIG. 43 on an enlarged scale showing a schematic representation of additional components of the transport table not seen in FIG. 43;

FIG. 52 is a view similar to FIG. 49 only showing a portion of a cutter at an exit end of the table;

FIG. 53 is a block diagram showing the position of the cutter service loop of the present invention; and

FIG. 54 is a view of a portion of the cutter service loop.

### DETAILED DESCRIPTION OF THE INVENTION

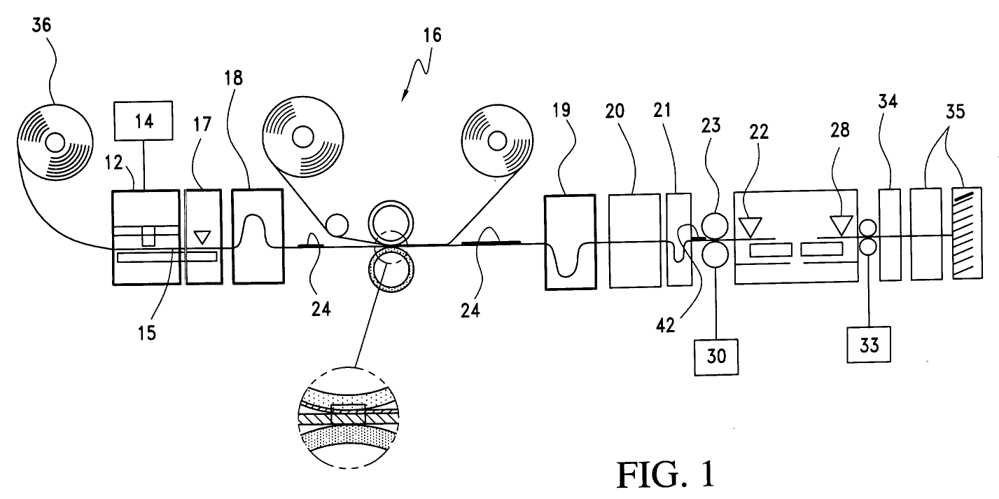

Referring to the drawings, FIG. 1 shows a schematic representation of the components of a photofinishing system generally indicated at 10. The components include a photofinishing printer 12 such as an inkjet printer or the like. The printer 12 is fed preferably from a continuous roll of print medium hereafter referred to as photographic paper 13. The printer 12 receives instructions from an image processor or controller 14 that determines the layout of the individual photographic images on a printed sheet 15. The image processor 14 is connected to the other elements of the photofinishing system, such as the cutters and buffers, and the laminator and backside printer as will be described in more detail below.

From the printer 12, the printed sheet 15 is delivered to a laminator 16 via a post cutter 17 and a print buffer 18. The printed sheet then passes through a first service loop 19 and also through an embosser 20 if desired and then on through the second service loop 21 to an entry cutter 22 via entry rollers 23. The post cutter 17 operates to cut a printed sheet 15 into printed segments 24, also referred to as printed media 24, as for each job or customer.

The print buffer 18, the first service loop 19, and second service loop 21 accommodate circumstances such as when the printer 12 produces sheets of different lengths and/or the laminator 16 and embosser 20 operate at different speeds from each other and/or other components, such as the entry cutter 22. The first service loop 19, the second service loop 21, and the print buffer 18 are able to accommodate sheets of various lengths and deliver them in an appropriate spaced apart relationship to the next component in the photofinishing system 10.

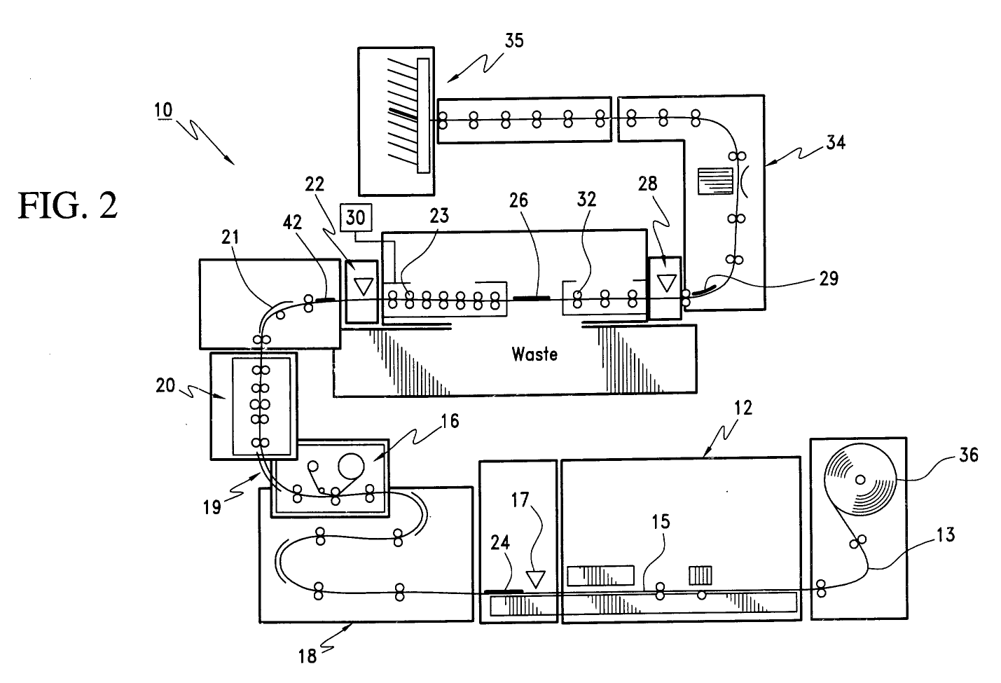

FIG. 2 shows a side view of the photofinishing system 10 including the printer 12, the post cutter 17, the print buffer 18, the laminator 16, the service loop 19, the embosser 20, the cutter service loop 21, the entry rollers 23, and the entry cutter 22. The entry cutter 22 cuts the printed, laminated and possibly embossed segments 24 into transverse strips 26, each strip representing a row containing one or more photographic prints. Each strip 26 then is transported to an exit cutter 28. The exit cutter 28 then severs the strip of photographs into individual prints 29.

The entry rollers, also known as drive rollers 23, are disposed between the print buffer 18 and the entry cutter 22. Preferably a stepper motor 30 under control of controller 14 activates the drive rollers 23. The function of drive rollers 23 is to deliver the printed sheet 24 to the entry cutter 22. As noted hereinabove, the sheets may vary in length so it is important that the drive rollers 23 be calibrated so that known increments in the rotation of the rollers produces a known linear translation of the sheet. Disposed after the exit cutter 28 is a set of exit rollers 32, also known as backside rollers or eighteen-inch rollers 32. Preferably a stepper motor 33 under control of controller 14 activates the backside rollers 34 as the individual prints 29 are transported through the backside printer 34 to the conveyor-stacker 35.

Printer

FIG. 3 shows a schematic representation of a portion of the photofinishing system 10. The photofinishing system 10 performs a sequence of steps for printing a series of images on paper 13. The paper 13 is fed through the photofinishing printer 12 such as an inkjet printer resulting in printed sheet 15. The paper 13 may comprise a plurality of stacked sheets that are individually fed into the printer 12. Preferably however, the paper 13 is drawn from a roll 36 so that the printer 12 has, in effect, a relatively continuous supply of the paper 13.

The computer 14, operatively connected to the printer 12, is arranged to receive photographic images contained in a data source 38. The computer 14 is programmed to organize a plurality of the photographic images in an array that makes most efficient use of the space on the paper 13. The computer 14 also can be programmed to accept other input data representing instructions from the customer for printing the order. These may include for example, the quantity and size of prints that are desired or optional instructions from the customer as noted hereinbelow.

In operation, the images to be printed first are received from the data source 38. The data source can be any conventional image source including, but not limited to, a strip of photographic negatives, one or more actual photographic prints or other image that is scanned for input into the system. The data source also can be a compact disk or computer memory containing a digital representation of the images or other stored electronic or digital file that can be directly inputted into the photofinishing system.

In operation, the images to be printed first are received from the data source 38. The computer 14 is programmed to organize a plurality of the photographic images received from the data source 38 in an array that makes most efficient use of the space on the print medium. Also inputted into the system may be customer instructions indicating the number of copies of each image that is desired. It should be appreciated that the images themselves may be of varying sizes or the customer may request enlargements of one or more images. The customer's instructions also may include a request to skip the printing of certain images contained by the data source 38. In any event, after the customers instructions as to quantity, size, etc. is inputted into the system, computer 14 determines a printing layout for the given width of the paper 13.

Once the printing layout is planned, the size of any space 39 to be left blank is determined. Thereafter, one of several events that can occur for utilization of this otherwise blank or wasted space 39. If the size of this otherwise waste space permits, it can be used for the printing of a diagnostic or test pattern to monitor various aspects of the photofinishing printer 12. For example, test pattern among other things can check the health and alignment of the print heads of the printer or color quality.

The printing of a test pattern can occur on a scheduled or routine basis and as part of the normal photofinishing operation and whenever the size of the blank space 39 permits. As an alternative or in addition to the diagnostic image, the computer can routinely cause the printing of promotional literature in the blank space 39. The promotional literature preferably relates to the photofinishing operation and can include, for example, a cents-off coupon on the next customer order. The printing of promotional literature can occur between the times a diagnostic image is printed and, if space permits, both the diagnostic image and promotional literature can be printed on adjacent portions of the blank space.

After the size of the otherwise blank space 39 is determined, the incremental cost of printing one or more additional photographs from the customer order in the blank space 39 also can be determined. This determination includes, for example taking into consideration the cost of the otherwise wasted media and possibly the cost other resources required for printing any additional print such as ink, laminate or other consumable. Once this cost is determined, the customer can be given the option of receiving one or more additional prints at a reduced price so as to allow the operator to recoup at least the cost of the otherwise wasted print media and preferably make an additional profit.

The computer 14, in response to the various inputs, then directs the printer 12 to produce the printed media 24 containing selected images needed to complete the customer's order along with other images selected for printing in the otherwise blank space 39. The individual images are then cut from the sheet and packaged to complete the customer's order.

It also is possible to utilize the otherwise blank space 39 for printing extra copies of photographs or printing promotional literature unrelated to the customer order otherwise appearing on the sheet 15. In this respect the input to computer 14 may include the orders and customer instructions from several customers contained in a queue for processing. In this case, the blank space 39 may be used to print an extra print for any of the orders in the queue. For example, the blank space 39 appearing on the sheet of prints for the first customer in the queue can be used for printing a photograph from the order of a second (or subsequent) customer in the queue. When the sheet is cut to separate the individual prints, the subsequent customer's print appearing in the space is separated and later added to the prints of the subsequent customer.

In a typical print format for a print size of 4 in.×6 in. (10.16×15.24 cm), the prints are laid out three in a row to form a row extending across a paper width of 13 inches (31.85 cm). Each customer order may comprise one or more such rows. As the paper 13 passes through the printer 12, the print layout determined by the computer is printed onto the paper by a traversing print head 40. Next the sheet is cut into individual job sheets 24 which are laminated and embossed to produce printed segments 42, as identified in FIG. 3. The print head 40 is conventional and need not be described in detail except to say that it comprises a plurality of nozzles (not shown) for directing drops of ink of different colors at the print medium to create the photographic images.

At the outset of the printing operation, the computer exercises the print head 40 to create a transverse fiducial mark 44, which may extend across the paper width and just below a leading transverse edge 46 of the printed media 24. The transverse fiducial mark 44 preferably is a stripe of a single color, most preferably a black or brown stripe. Printed images 48 then immediately follow the transverse fiducial mark.

During the course of printing the images, the computer causes the further exercise of the print head 40 as the print head makes repeated transverse passes back and forth across the paper to generate the images. The computer 14 in effect specifies the location of the fiducial marks on the print medium by causing the nozzles to exercise immediately before and/or after each printing pass of the print head. The exercise can occur at the beginning of each transverse printing pass or at the start and end of each pass.

Regardless of when the exercise occurs, at least one nozzle of the print head is used so that the print head ejects a series of ink drops just before and just after the printed image. This forms a pair of longitudinal fiducial marks 50, one along each longitudinal edge 52, also referred to as a lateral edge 52, of the paper between the edge and the photographic images 48 in one of the blank areas. These marks form a printed pattern composed of a combination of primary subtractive printing colors. Each of the colors contained in the printing system is used with the amounts and relative ratios of each color being determined based on the specific necessity of each color to be exercised.

Thus the exercise of selected nozzles is in accordance with a determined print pattern selected to exercise those nozzles needing exercise. It also should be appreciated that from time to time the particular determined print pattern might change during the course of operation because different nozzles may need to be exercised at different rates. Different print patterns and changing print patterns from time to time as necessary insures that over time each of the nozzles is exercised. The determination of the frequency and order of the exercise of particular nozzles to insure proper operation is all within the skill of the art.

The longitudinal fiducial mark 50 formed by the nozzle exercise are of a known width and a known distance from each longitudinal edge 52 of the paper and the printing of the images 48 commences immediately after the longitudinal fiducial mark 52. The longitudinal fiducial marks also can be made by selective exercise of nozzles in the print head. For example, to make the mark more distinctive to a sensor, such as an optical sensor, as will be discussed below in more detail.

In one embodiment, each transverse pass of the print head 40, a portion of each fiducial mark 50 and a portion of a printed image are formed. In this way the fiducial marks are formed during the course of printing the photographic image with no space between the fiducial marks 50 and the adjacent edge of the image. Preferably, each image is over printed by about one millimeter about all four sides and the images are printed with no space between each image. Accordingly, for a typical arrangement of three 4-inch (10.16 cm) wide prints arranged in a row across the segment, the two longitudinal fiducial marks are each 5.7 mm wide and 4 mm from the paper edge. In addition the 1.0 mm of overprinting adds 6 mm to the width of the printed field adding to the total paper width of 13 inches (33.02 cm). After the printing order is completed, the printed segment 42 is cut from the continuous supply by any appropriate cutter associated with the printer.

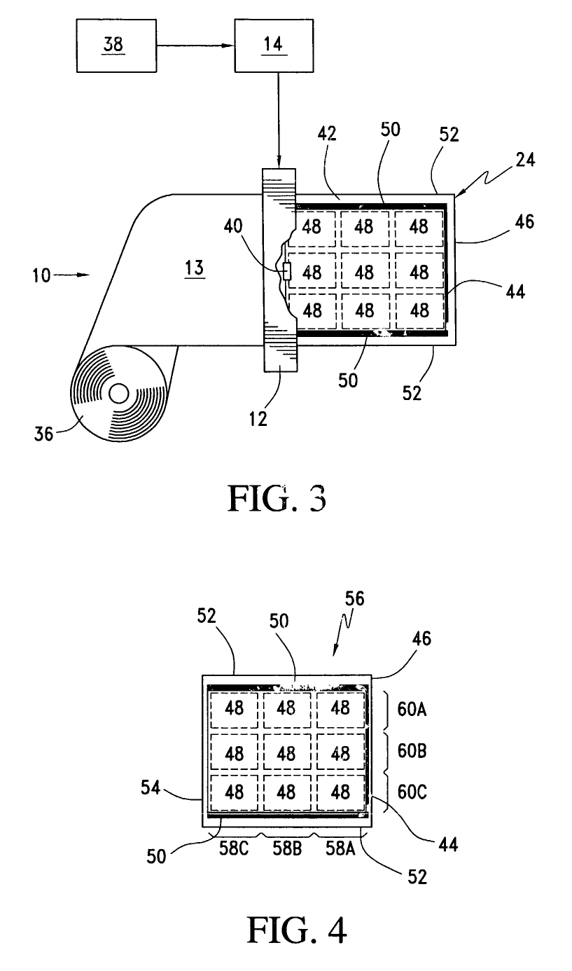

A typical printed segment 42 comprising a layout for nine 4×6 prints is shown in FIG. 4. In this respect the printed segment 42 severed from the paper supply has leading and trailing edges 46, 54 respectively and opposite lateral edges 52. The print head applied transverse fiducial mark 44 extends across the leading edge 46 and immediately in advance of a printed field that is bounded on its lateral sides 52 by the longitudinal printer fiducial marks 50. Thus a segment 56 as shown in

FIG. 4 comprises an entire printed sheet of printed media 24 and encompasses the entire printed field bounded on three sides by the leading edge fiducial mark 44 and the two longitudinal fiducial marks 50. Disposed in the print field is a set of images comprising individual photographs 48 that are shown in dotted line in this field because the over printing about the edges of each print merges with the over printing of an adjacent photo in the format as shown. In the format shown in FIG. 4, there are nine photographs in the set arranged in three transverse rows or subsegments 58A, B and C with the leading and trailing edges of the photographs in each row being aligned. The photographs also are arranged in three longitudinal columns 60A, B, C with the lateral edges of the photographs in each columns also being aligned.

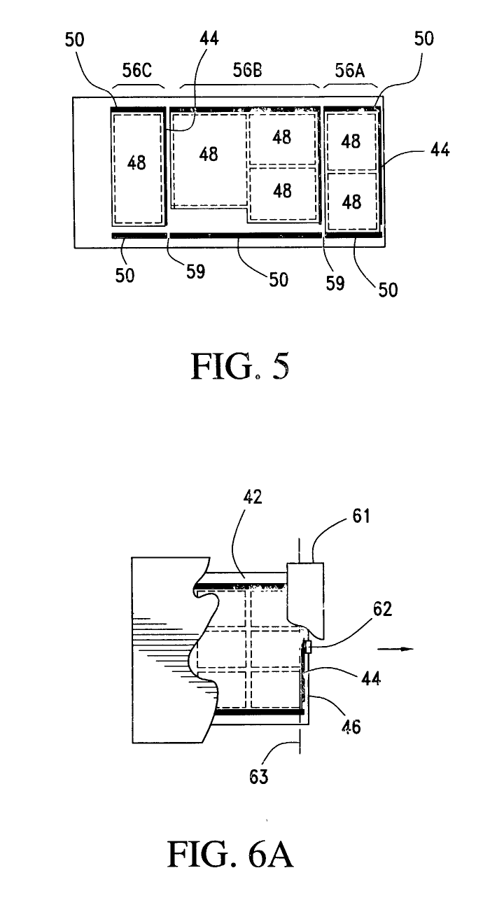

Other layouts are possible depending upon the arrangement created by the computer 14. For example, prints of various sizes can be grouped together so long as there is one dimension (either length or width) in common. This is shown in FIG. 5 wherein a plurality of photographs are arranged in three segments wherein the three segments are all on the same printed sheet. There is the first segment 56A containing only two prints, each over printed and with no space between. The second segment 56B contains four smaller prints (also over printed and with no space between) and the third segment 56C contains one panoramic print. Each of the segments 56A, B and C comprise a printed field bounded on three sides by the transverse and longitudinal fiducial marks 44, 50 respectively. In this case however, the segments are short in that each comprises a single row of prints separated by white space 61. Preferably, the segments, which may be of various widths, are left side justified.

In some cases, processing shorter segments is advantageous, such as the end of a customer order. In such cases each of the short segments such segments 56A, B and C is separated by white space 61 and there is a transverse fiducial mark 44 immediately in advance of each segment. These segments are cut and separated from the larger sheet wherein each contains transverse and longitudinal fiducial marks to provide registration information.

Cutter

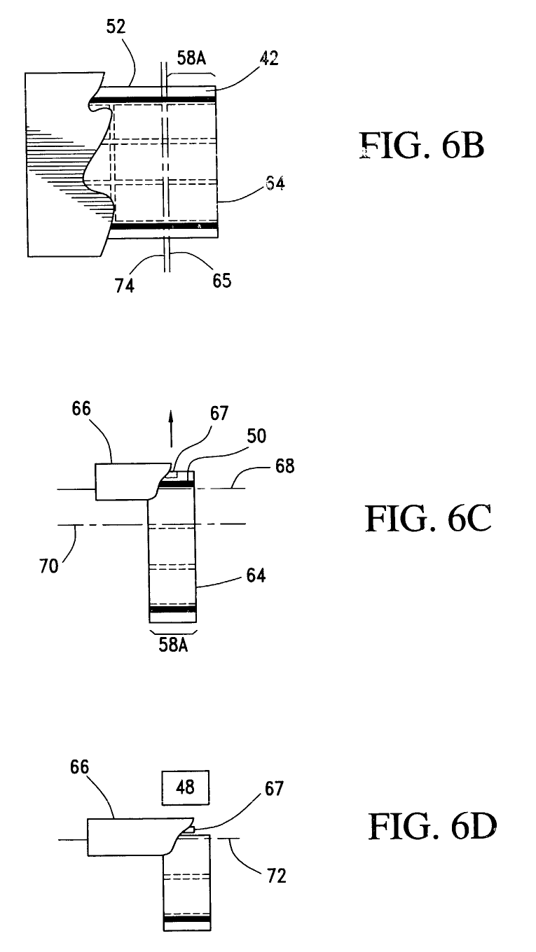

Steps in an operation for cutting the segment 56 of FIG. 4 into individual prints is illustrated in FIG. 6. FIG. 6A shows that the segment first is advanced in into the entry or first cutter 22 in the direction of its leading edge 46. As a first step, any suitable first sensor 62 in the cutter such as an optical sensor detects the transverse fiducial mark 44. Since the image immediately follows the transverse fiducial mark, the first cutter 22 is able to make a first transverse cut along a first line 63. This forms a leading edge 64 of the photographs in the first row 58A as shown in FIG. 6B. The width the row of photographs 58A is known so that the cutter can now draw the segment into the cutter to a second position for making a second cut along a second line 65 that forms the trailing edge of the first row of prints. In this fashion a strip or subsegment 58A of the photographs cut to size is severed from the segment 56 as shown in FIG. 6C.

The severed subsegment 58A then is moved in the direction of a lateral edge 52 to the second cutter 28 that is arranged orthogonal to the first cutter 22. This second cutter 28 also includes a second sensor 66, which detects the portion of the printer longitudinal fiducial mark 50 located between the lateral edge and the printed images. The longitudinal fiducial mark thus forms a second fiducial mark arranged orthogonal the first fiducial mark 44. Since the photographic image in the row immediately follows the longitudinal fiducial mark, the second cutter 28 is able to make a first longitudinal cut (third cut) along a third line 68 that forms a lateral edge of the first photograph in the row. The width of each photograph in the subsegment is known so that the second cutter 28 can draw the subsegment to a second position for making a second lateral cut (fourth cut) along a fourth line 70 that forms the second lateral edge of a first print. In this fashion a first of the photographs 48 in the subsegment is severed from the sheet as shown in FIG. 6D.

Also it is known that the over printing can be fixed at 2 mm or can be sized to a dimension which is proportional to the size of each print. With this information second cutter 28 can draw the remaining portion of the subsegment into the cutter by this distance so a third lateral cut 72 (fourth cut) can be made thereby forming a first lateral edge of a second print in the subsegment. Similar advances are made as noted above until all of the individual prints have been cut from the subsegment.

Either while the second cutter 28 is performing its function or after the completion of its function, the first cutter 22 indexes the remaining portion of segment 56 by the amount of the over printing between the rows 58A and 58B (FIG. 6B). The first cutter 22 can now make a cut along a line 74 to form the leading edge of the photographs comprising row 58B, The cutting steps are then repeated first to sever a subsegment containing the row of photographs 58B from the sheet and then to cut the subsegment into individual photographs or prints 29.

In the case of the arrangement shown in FIG. 5, each of the segments 56A, B, C first is separated from the remaining segments with a rough cut through the white space 61. Each of the separate segments in turn is delivered to a cutter where the first and second cuts 63, 65 (FIG. 6B) are made. Each of the segments then is moved laterally to a position for making the separate lateral cuts 68, 70 and 72 as necessary to sever the separate prints.

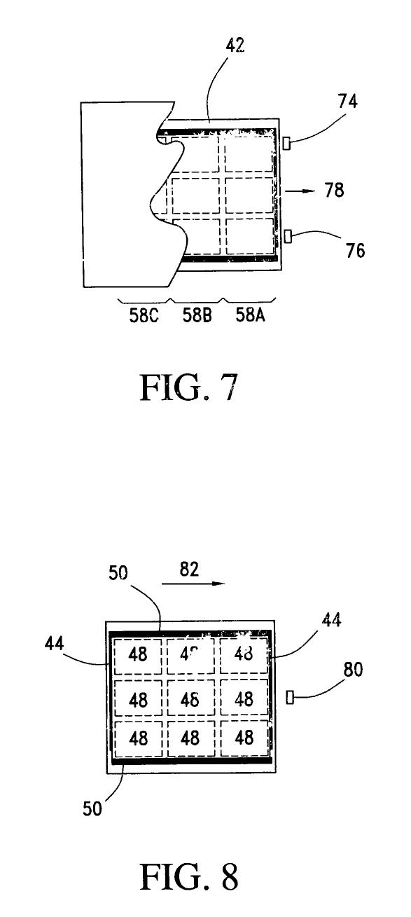

As noted above, the present invention is able to correct for various printing errors. For example, FIG. 7 illustrates the detection of skew in the transport of a segment 56 to a cutting position. In this respect to a third pair of transversely spaced sensors 76 arranged so as to extend across the path of segment motion (indicated by arrow 78) can measure the angular skew of the fiducial mark 44. The transport mechanism (not shown) can then make an appropriate adjustment to compensate for the skew so that the segment is properly aligned with the cutter. A similar arrangement can correct for skew during the lateral transport of a subsegment to a cutter for severing individual prints from the subsegment.

A further application of the present invention can be understood by reference to FIG. 7. FIG. 7 shows an arrangement of two spaced-apart transverse fiducial marks 44, one mark being associated with each segment. With the distance between the adjacent fiducial marks 44 being known, a single fourth sensor indicated at 80 can be used to measure the distance between the fiducial marks as the larger sheet is moved in the direction of arrow 82.

This longitudinal distance information is useful to provide for the calibration and correction of errors in the transport mechanisms used to move the larger sheet in a longitudinal direction to a cutting position. Such distance information also can be gleaned from any third fiducial mark located parallel to and spaced a known distance from the transverse mark 44. Similar information to calibrate and correct the transport mechanisms moving individual segments or subsegments in a lateral direction can be obtained by having a fourth fiducial mark parallel and spaced a known distance from either of the second fiducial marks 50.

Lamination of the photographic printed media 24 is a feature of the present invention through a lamination process known as “peel apart” lamination using a peel apparatus. The peel-apart technique transfers an overcoat material from a donor support to a printed image. This transfer is often done through a process in which the donor support with the overcoat and the printed media are brought together mechanically with pressure and then heat is applied for a specific exposure time period. This process causes the overcoat material to transfer from the donor to the printed image, so that the donor can then be peeled away.

Laminator

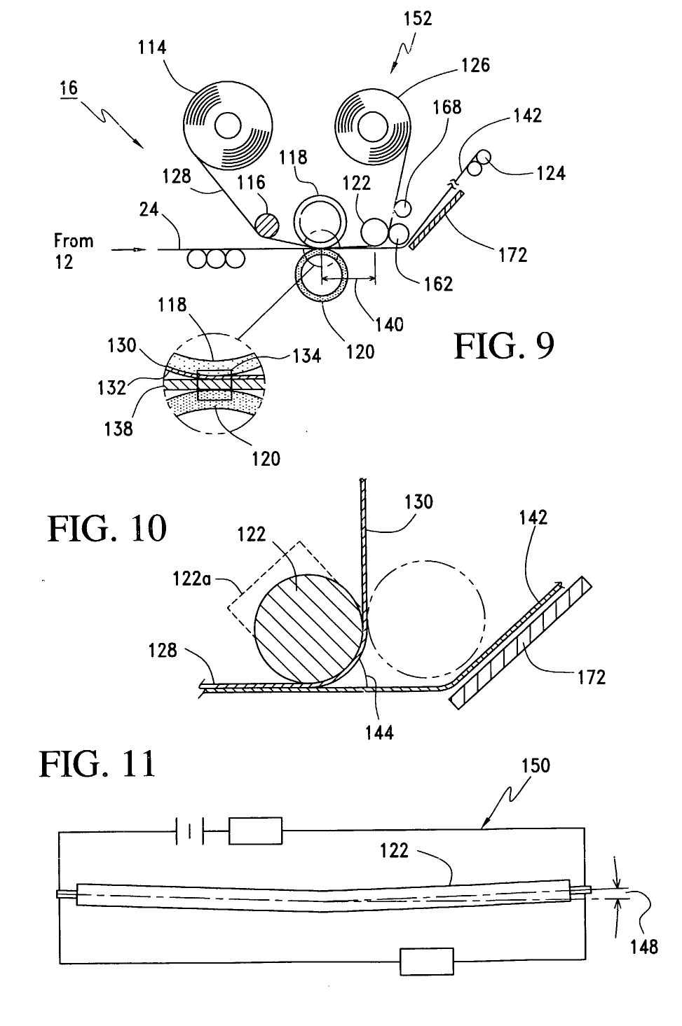

FIG. 9 is a mechanical schematic diagram of the laminator, also referred to as the overcoat application apparatus 16. The overcoat application apparatus 16 consists of an entry roller 112, a donor supply reel 114, a donor guide bar 116, a heated fuser roller 118, a pressure roller 120, a primary peel bar 122, an exit roller 124 and a donor take-up reel 126.

The basic function of the overcoat application apparatus 16 is to thread a laminate carrying donor 128 between the donor supply reel 114 and the donor take-up reel 126. The donor is preferably a multi-layer web that in its simplest form consists of a donor support, also known as a donor 130, and an overcoat material, also referred to as a laminate 132. The threading is such that the laminate carrying donor 128 follows a path around the donor guide bar 116, through a nip 134 created by the heated fuser roller 118 and the pressure roller 120, and around the first peel guide 122. In a normal idle mode, the fuser roller 118 is disengaged from the pressure roller 120 so that no transport of laminate carrying donor 128 is performed.

When the overcoat application process is ready to be performed, the pressure roller 120 is pressed against the heated fuser roller 118. Simultaneously, the heated fuser roller 118 is rotated, preferably at a constant speed thus transporting the laminate carrying donor 128 through the nip 134. Tension control on both the donor supply reel 114 and donor take-up reel 126 allow this donor transport to be done in a controlled fashion. In addition to all of these events, the sheet or continuous roll of printed media 24 is fed onto the entry roller 112 such that the leading edge 46 of the printed media 24 enters the nip 134 along with the laminate carrying donor 128.

At this point, thermal energy from the heated fuser roller 118 is transferred into the portion of the laminate carrying donor 128 and printed media 24 that are in the nip 134. The length of thermal energy exposure time and the amount of thermal energy transferred to the laminate carrying donor 128 and the printed media 24 are a function of the transport speed created by the rotation of the heated fuser roller 118 and the width of the nip 134 and the temperature and thermal characteristics of the fuser roller 118, the laminate carrying donor 128, overcoat material, also known as laminate 132, the printed media 24, and the pressure roller 120. During this exposure time, the laminate carrying donor 128 and printed media 24 are fused together. The fused composite continues until encountering the first peel guide 122. The distance between the nip 134 and the first apex of the first peel guide 122 is referred to as the cooling distance 140.

FIG. 10 shows the donor 130 is directed to the donor take-up reel 126 at an angle preferably approaching 90 degrees while a laminated printed article, hereafter referred to as the laminated printed media 42, is directed to the exit roller 124. It should be noted that the article to be laminated may include other items such as clothing, as is well known in the art. The angle between these redirections is referred to as a peel angle 144. The goal of this redirection is to accomplish the following functional requirements:

a) The overcoat material 132 is completely transferred from the donor 130 to the printed media 24 such that a completely uniform coating is produced.

b) No contamination is generated.

c) No laminate-carrying donor 128 or printed media 24 transport jams are generated from the excess lamination material, generally called flash, at the trailing edge 54 of the laminated printed article.

d) The process works over a wide range of printed media 24 sizes and types, donor 130 and laminate 132 sizes and types, and various settings and configurations of the overcoat application apparatus 16.

Up to this point, the process that has been described is similar to the normal practice. The Kodak Picture Maker example discussed in the background section is an example of this practice other than the fact that a thermal printhead is used to perform the fusing process instead of a heated fuser roller 118.

FIG. 11 shows a front view of the first peel guide of the first peel guide 122 and illustrates a first peel guide curvature 148 and a first peel guide peel bar wrap angle, geometric features of the overcoat application apparatus 16 associated with the peeling process.

FIG. 11 also shows a peel guide thermal system 150 capable of controlling the temperature after the laminated printed media exits the fuser, in this case by controlling the temperature of the area upstream of first peel guide using a fan. The thermal system could also control the temperature of the first peel guide, platen or other devices in contact with the laminated printed media.

One way that the thermal system 150 can control the temperature of the laminated printed media is by using a temperature reference signal that provides a control signal to a comparator. The comparator takes the temperature reference signal and subtracts a temperature feedback signal that results in a temperature error signal. The temperature error signal is then fed into a controller that in turn produces a temperature control signal. This temperature control signal is then used to drive a thermal device. The thermal device in turn heats or cools portions of the overcoat application peel apparatus 16. A temperature sensor senses the first peel guide temperature and converts it into the temperature feedback signal.

The intent of the control loop is to keep the first peel guide temperature at a level equivalent with the temperature reference signal. The current preferred method of thermal control is to cool the laminated printed media after it is heated to between 90-115 degree Celsius down to below 60 degree Celsius. This is accomplished with the aid of one or more of the following cooling methods: a) conduction, using a metal in contact with the laminated printed media, b)convection, using a fan or similar device and c)radiation.

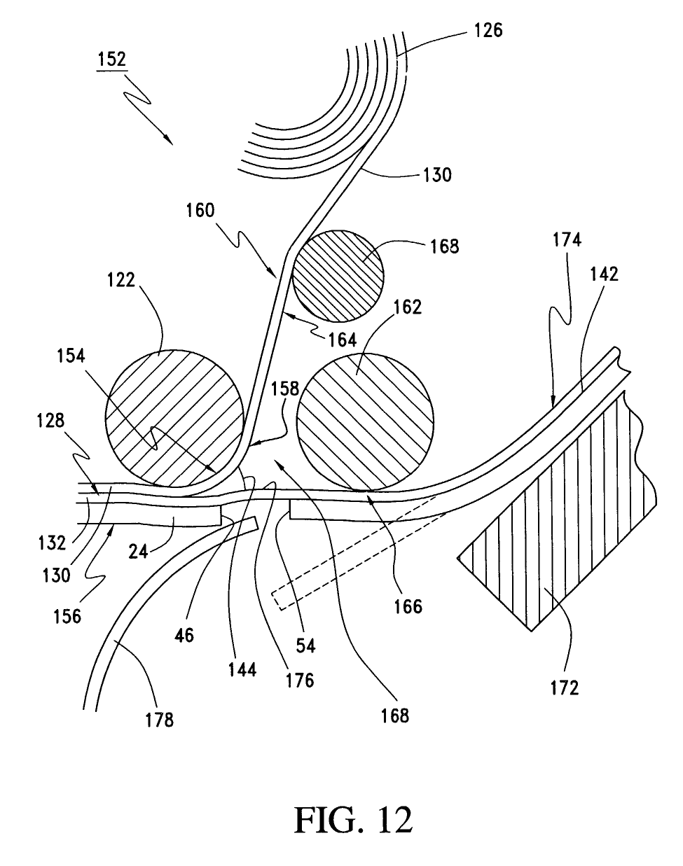

FIG. 12 shows the overcoat application peel apparatus 152 of the present invention for maintaining the peel angle 144 at a peel point 154 where a donor 130 is peeled from the laminated printed article 42 between a first paper path 156 downstream a fuser roller 118 and a donor path 158 upstream a donor take-up reel 126, where the first peel guide 122 is adjacent the first paper path 156 on a first side 160 of the donor and a second peel guide 162 is adjacent the first peel guide 122 on a second side 164 of the donor such that the second peel guide 162 supports the printed media 42 at a support point 166. A donor guide 168 adjacent the donor path 158 on the second side of the donor 164 such that the donor guide 168 resists tension from the donor take-up reel 126 thus maintaining a substantially constant peel angle 144 as the donor take-up reel 126 changes in diameter.

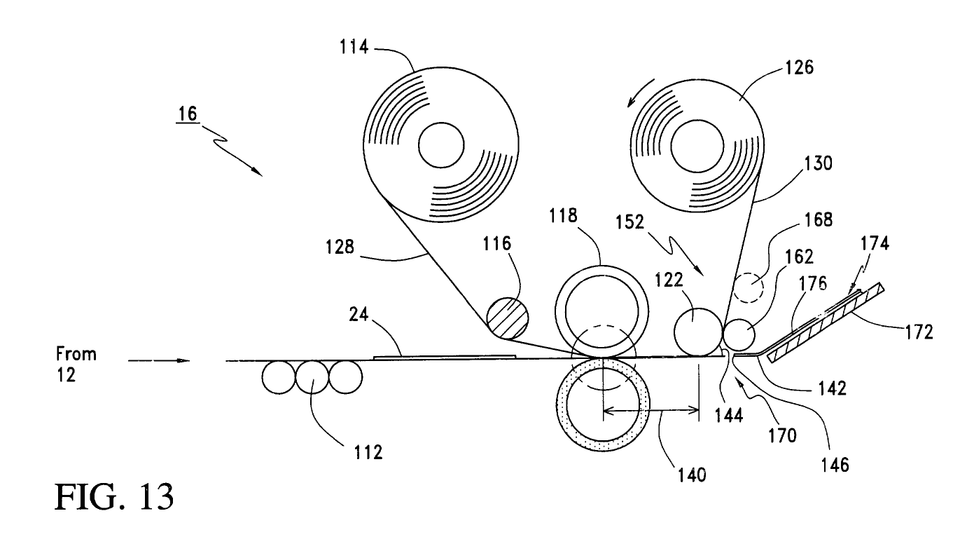

FIG. 13 shows the overcoat application peel apparatus 152 where the first peel guide 122 is adjacent the second peel guide 162 forming a peel nip 170 where the donor 130 is trained through the peel nip 170. The overcoat application peel apparatus 152 can also include a tilted take-up platen 172 arranged upstream of the second peel guide 162 along a second paper path 174 for the laminated printed article 42 including interstitial laminate 176, commonly referred to as flash. The angle of the tilted take-up platen 172 should be sufficient to release the interstitial laminate 176 from the laminated printed article 42 at a media trailing edge 54.

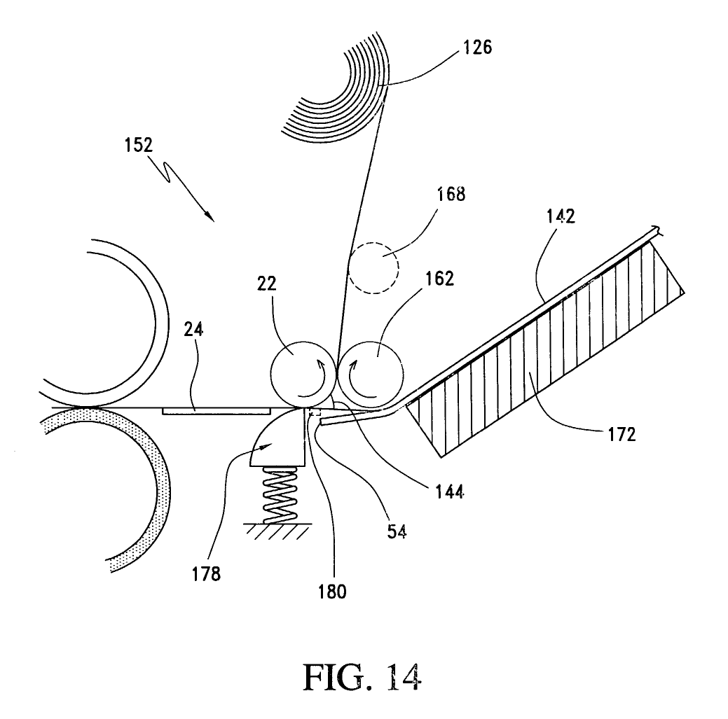

FIG. 14 shows the overcoat application peel apparatus 152 including a paper support 178 that is adjacent the printed media 42 proximate the peel point 154 to support the printed media 24. The overcoat application peel apparatus 152 can be built with the paper support 178 including a curve spring or other similar device that would also cause the printed media 24 to flex. The first and second guides may be stationary bars, stationary rollers, or energized rollers as is that is well known by one skilled in the art.

The first peel guide 122 and the second peel guide 162 act in concert to cause the unused laminate to be effectively removed from the trailing edge 54 as it moves through the overcoat application apparatus 16. This removal process may be enhanced by reversing the direction of the laminated printed media 42 and/or coordinated by the use of a sensor 180 that detects the trailing edge 54 of the laminated printed media 42 before it passes the first peel guide 122. The first peel guide 122 and second peel guide 162 of the overcoat application peel apparatus 152 may be tapered. It has been found that a tapered guide more effectively removes the unused laminate from the sides of the laminated printed media 42. This is especially important when the laminated printed media is inbound, that is the media is slightly smaller in size than the laminate used to coat the printed media 24. Inbound printed media is a product designed to use the complete surface of the printed media 24. This is in contrast to other printing processes that leave an edge of unlaminated printed media, referred to as outbound media.

In addition to significantly improving the peeling parameters, other advantages are achieved with the use of the overcoat application peel apparatus 152. First the overcoat application peel apparatus 152 helps flatten the laminated media 42 and thus reduces buckling as discussed above. Secondly the overcoat application peel apparatus helps to eliminate the normally tight tolerances on the design distances. For example, it has been shown that if the overcoat application peel apparatus 152 is located a reasonable distance (>1 inch) from the nip 134, there is a significantly wide window of peel bar parameters that allow an excellent peeling process. This allows a wider range of materials and equipment tolerance as well as the set point designs for the geometric parameters of the system. Also the overcoat application peel apparatus 152 improves the functionality of the overcoat application apparatus by helping tighten the laminate-carrying donor 128 for stable transport control. This in turn helps assure uniform coating of the printed media 24.

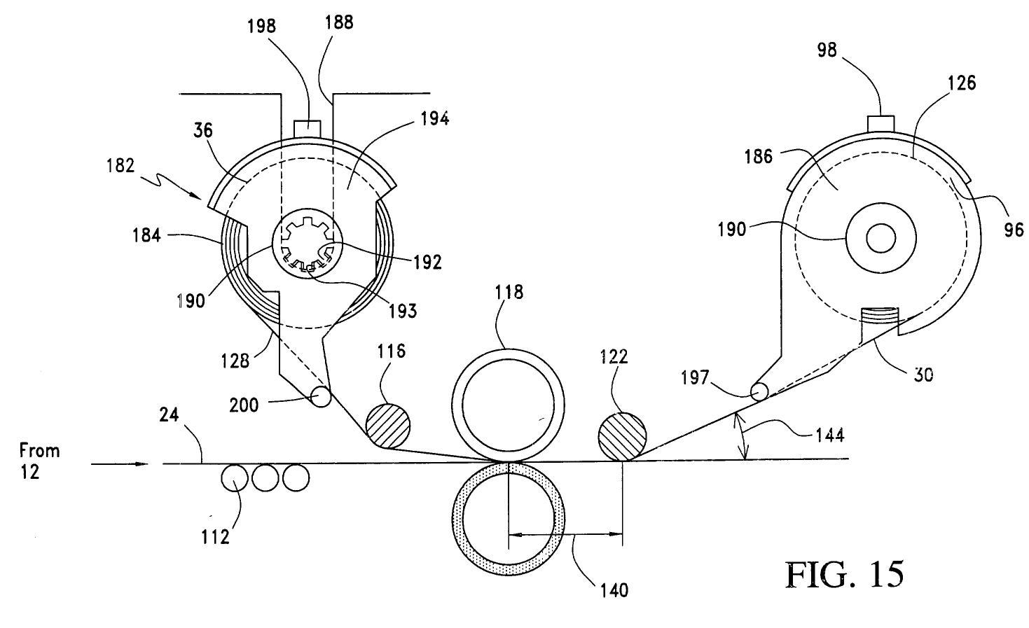

FIG. 15 shows the laminate cartridge 182 overcoat peel apparatus 152 for the photofinishing system 10. The laminate cartridge 182 of FIG. 15 has first spool 184 with a supply of laminate carrying laminate carrying donor 128 and a second spool 186 where the donor 130 is wound. The first spool 182 of the laminate cartridge 182 may sit in a slot 188 of the overcoat application apparatus 152 holder only a portion that is shown containing the slot 188. At least one of the spools 184, 186 may have a plurality of ratchet teeth thereon. The spools 184, 186 having a core 190 having a plurality of ratchet teeth 192 constructed to fit into tooth repository 188. The spool 184, 186 is movable within the slot 188 from a first position in which the ratchet teeth 60 engage and a second position in which the ratchet teeth 192, and consequently the core, are disengaged from the repository 188 so that the spool 184 will turn freely.

FIG. 16 shows the laminate cartridge 182 without the spools 184, 186. The laminate cartridge 182 has a first holder 194 and a second holder 196. The laminate cartridge 182 also has one or more handles 198 attached to the one or more of a first holder 194 and second holder 54. FIG. 16 shows these handles 198 attached to the first spool holder 194 and the second spool holder 196. The first and second holders 194, 196 can be constructed of a durable but light plastic.

There are many designs used to accommodate the first and second holders 194,196, as well as the handles 198. An ergometrically efficient cartridge design is necessary as will be discussed in more detail below. The laminate cartridge 152 has one or more guide bars. FIG. 16 shows a first guide bar 195 and a second guide bar 197 for holding tension on the laminate substrate 128.

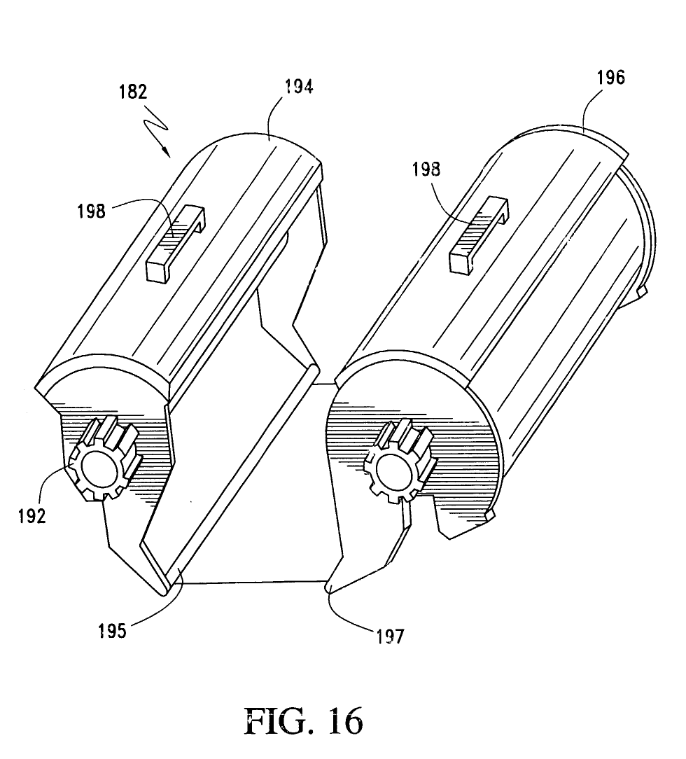

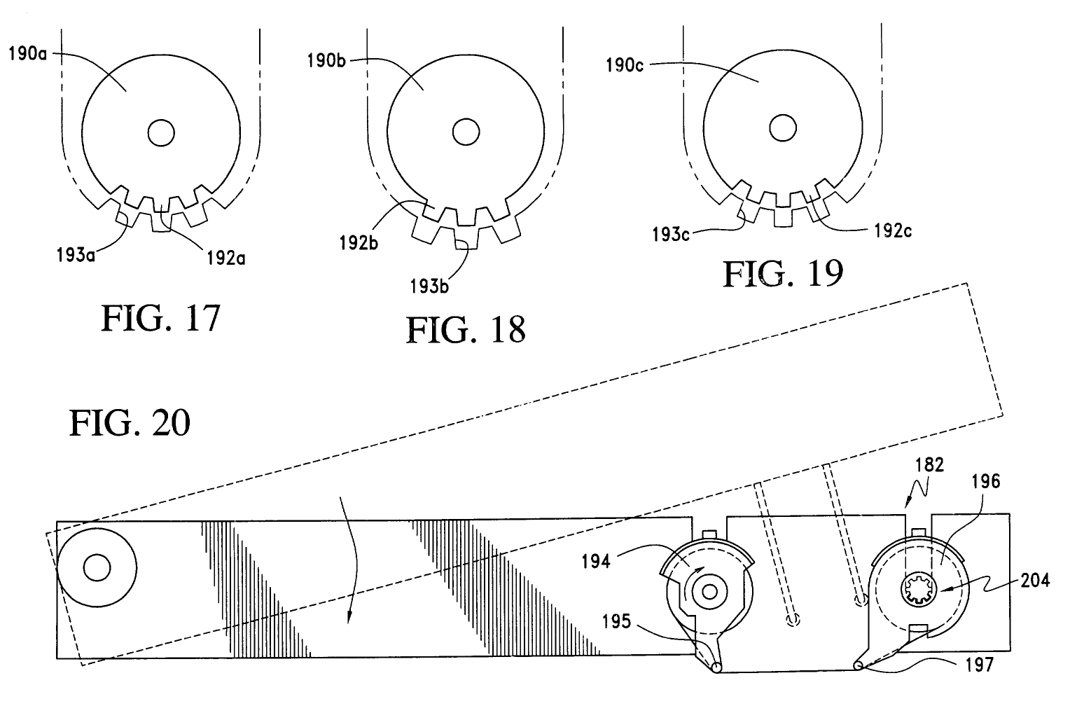

FIGS. 17, 18, and 19 show three embodiments of the ratchet teeth 192 and associated repository 193 in which the ratchet teeth 192 and associated repository 193 are designed in different manners. FIG. 5 shows the ratchet teeth configured such that the teeth 192 do not protrude from the circumference of the core 190 when seated in the associated repository 193. This is advantageous when space and clearances are a concern because this design is very space efficient.

FIG. 18 shows ratchet teeth 190 configured such that the teeth 190 do extend beyond the core 190 circumference when seated in the associated repository 193. Finally FIG. 19 shows a ratchet teeth 192 that may or may not extend beyond the circumference of the core 190 when seated in the associated repository 193 but have a square shape. It is apparent to those skilled in the art that various shaped teeth 192 could be used in this invention and these shapes are shown to illustrate particular possibilities but not to limit the possible tooth shape associated with the invention.

The laminate cartridge 182 in FIG. 20 has been ergometrically designed so that the spacing of the handles 68 is such to make easy movement from the source of the cartridge to its placement in the holder for the overcoat application apparatus 152. Preferably, the laminate cartridge has a flexible frame with an ergonomically beneficial design which allows at least the two spool holders to accommodate a spacing between the handles that accommodates a variety of body sizes thus allowing good ergonomic form while loading the laminate reel and getting it ready for application to a media while keeping the cost low. Low cost is an issue since the cartridge is a consumable item and may be thrown away after the laminate is used up. These laminate reels are large (4 inches in diameter and 13½ inches long for example and heavy, possibly 8.8 pounds each).

The laminate cartridge 182 is taken out of the packaging by the handles 194 and set into the overcoat application apparatus holder. The guide bars 195 tension the laminate-carrying donor 128, 197 as discussed above. A ratchet system 204 includes the slot 188 with a tooth 196 and repository 193 combination as discussed above and as shown in FIG. 20. The system 199 keeps the spent laminate from unwinding from the take-up spool.

In order to keep the cost low, the cartridge has been designed with independent handles on each reel or spool with a minimum of plastic and parts. This is a low cost system that has excellent ergonomics, for cartridge positioning during loading. The web remains taut on insertion into the mechanism as discussed above.

Print Buffer

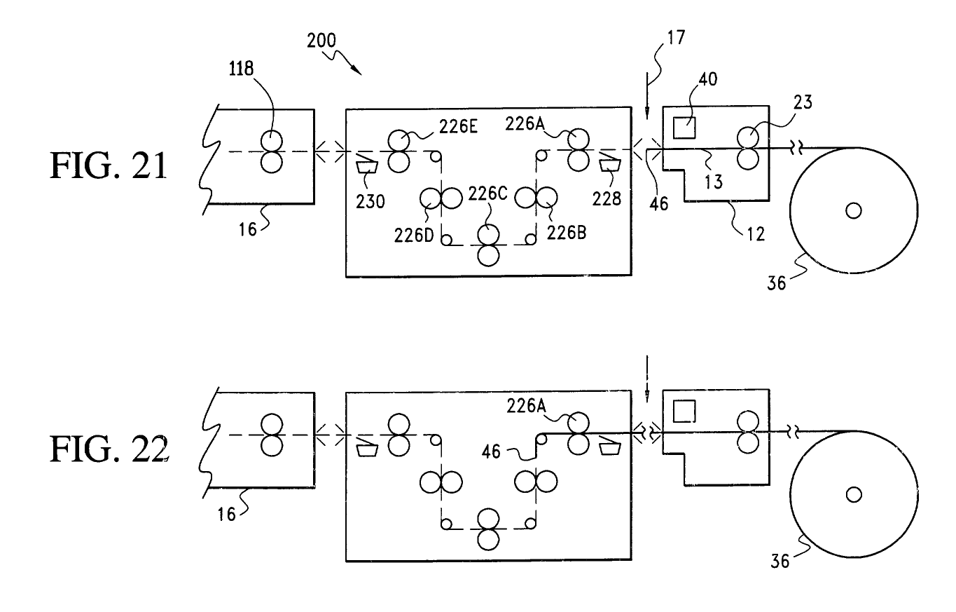

Drawing FIG. 21 shows a schematic representation of the buffer 18 of the present invention generally indicated at 200. The buffer is disposed between the photofinishing inkjet printer 12 and the laminator 16 located downstream of the printer 12. The inkjet printer 12 is described above and includes a print head 40 containing a plurality of nozzles (not shown).

The print head is mounted for movements back and forth across the photographic paper 13 (in a direction normal to the plane of the figure) wherein a portion of a photographic image is printed with each scan or pass of the print head. While the paper can be fed in sheets to the printer, it is preferred that the paper supply be the roll 36 so the supply is continuous. Drive rollers 23 within the printer feed the paper to the print head and step the paper forward for each printing pass of the print head. Thus the movement of the rollers is intermittent in that the paper first is indexed or stepped forward at a peak speed, then movement is stopped and the paper is held for a printing pass of the print head.

After the pass of the print head is complete, the paper is indexed forward again and stopped for the next pass. In this fashion a plurality of passes or scans across the paper will generate the photographic image and the speed through the printer in a first mode of operation is an average taking into consideration the peak speed or index time and the pause time for each scan. Each indexing of the paper is a precise movement that is adversely affected by any external resistance to the movement of the paper or by tugging on the paper. The force that can be applied to the paper without degrading quality depends on the particular printer. In one embodiment of this invention, the printer can sustain a tugging force of just under 100 grams without degrading the image.

After completion of a printing operation, the printed portion is ejected from the printer by the rollers 23 in a second mode of operation comprising a continuous movement of the printed portion. The printed portion then is cut from the continuous supply by the knife, also known as a post cutter 17. Accordingly, for purposes of the present invention it should be appreciated that the start/stop movement during the printing operation in a first mode of operation is at an average first speed whereas the ejection of the completed print occurs in a second mode of operation at a second speed that is faster than average speed of the printing operation.

In some printers of the type with which the present invention may be employed, the printer may occasionally reverse the motion of the paper during printing. This most commonly occurs during servicing of the printer to reduce waste.

From the printer 12, the cut off printed portion referred to hereafter as the segment 24 enters buffer 200. The buffer 200 has an internal track that defines a path of travel (indicated by dotted line) for delivering the segment 24 to the downstream laminator 16. The laminator 16 has been described above. The laminator receives the segment 24 and applies a protective laminate (not shown) to the printed surface of the segment 24 as the segment moves through the laminator 16. Preferably, the laminator 16 operates at a third speed somewhere between the average first speed of the printer and the ejection or second speed of the printer 12. More generally, the laminator 16 operates at a speed faster than the first average speed. Accordingly, one function of the buffer 200 is to permit the hand off of the segment 24 between the two devices operating at different speeds.

To accommodate the hand off, the buffer 200 of the present invention defines a path of travel, as shown in dotted line in FIGS. 21 to 26, that is preferably at least as long as the longest segment 24 produced by the printer 12. Disposed along this path of travel is a series of drive rollers 226. These rollers nip against the segment and are driven so as to move the segment through the buffer preferably at a constant speed that most preferably is faster than the average first speed of the printer and slower than the ejection speed of the printer. Contact switches 228, 230 at the inlet and exit respectively of the buffer operate to start and stop the action of the rollers 226.

A typical drive roller mechanism is shown in FIG. 27. As shown in FIG. 27, the drive roller mechanism includes one or more drive rollers 226 carried by a drive shaft 232. The drive shaft, in turn, is connected to a drive motor 239. A one-way clutch 234 transmits force from the drive shaft to each roller for driving the roller in the direction indicated by arrow 236. The one-way clutch also permits the roller to overrun the shaft so the clutch frees the roller to rotate faster than the drive shaft in the direction of arrow 236. A slip clutch 238 is disposed between the drive shaft 232 and the motor 239. The slip clutch limits the torque or drive force exerted by the roller on the segment in the direction of arrow 236 for purposes set out hereinbelow. Preferably, the force limit of the slip clutch is set somewhere below the maximum force that can be tolerated by the printer without degrading the image, to provide a safety factor. When used with the printer described above, that can sustain just under 100 grams of force without degrading print quality, a slip clutch limit of about 60 grams can be used.

Operation will be described beginning with reference to FIG. 21 wherein the photographic paper 13 is being fed through the printer 12. As an image is printed, rollers 23 intermittently index the paper by the print head 40. At each pause in the indexing cycle, the rollers hold the paper and the print head scans across the paper to print a portion of the image. As the start/stop printing movement continues, the leading edge 46 of the paper enters the buffer 200. Eventually the paper progresses into the buffer and engages the contact switch 228. This starts the operation of the drive rollers 226 within the buffer 200. The drive shaft operating through the slip clutch 238 and one-way clutch 234 drives these rollers at a constant speed that, as noted above, is faster than the printing speed of the printer but slower than the eject speed.

When the leading edge 46 of the paper enters through the nip between the first set of buffer drive rollers 226A, as shown in FIG. 22, these rollers will begin to tug on the paper. This invention limits the tugging force to a level that will not tend to disrupt the printing operation and degrade the print quality. The slip clutch or torque limiter 238 that couples the drive motor 239 to the drive shaft 232 and the one-way clutch 234 between the drive shaft and the rollers are set up to prevent the rollers 226A from tugging on the paper while movement of the paper is paused. This is done by setting the slip clutch 238 so as to limit the drive force exerted on the paper by the rollers 226 to a level below that which can cause an adverse effect on print quality.

As the paper is indexed forward for the next printing scan of the print head 40, the engagement of the paper in the nip between rollers 226A must not resist the sudden and rapid forward stepping of the paper at a peak speed. Such resistance also will adversely affect print quality. To prevent such resistance, the one-way clutch 234 between the drive shaft 232 and the roller allows the rollers to overrun the shaft. In this fashion the paper, as it is stepped forward, will exert sufficient force on the rollers 226A to overrun the shaft so there is little or no resistance to such forward movement.

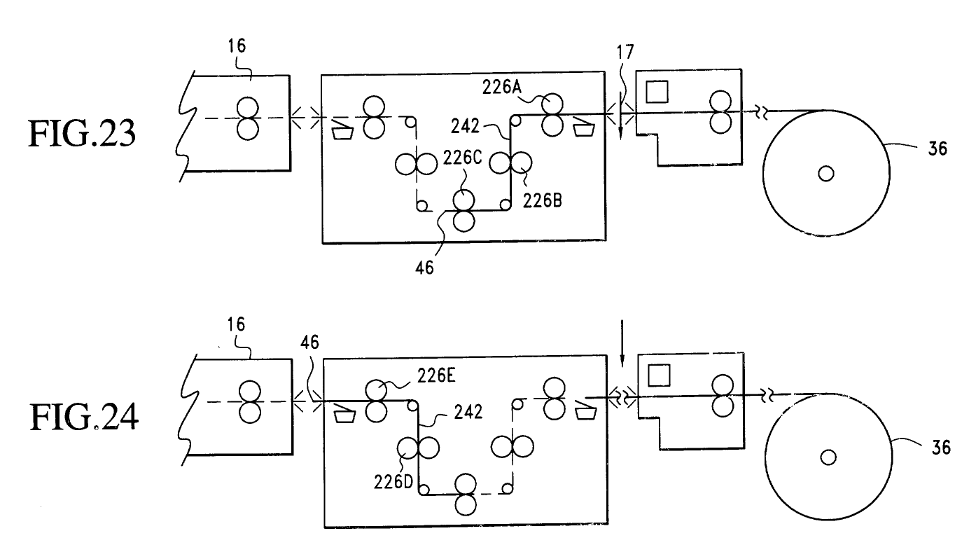

After the printing operation is complete, the printer ejects the printed portion of the paper. If the paper is ejected at a speed faster than can be accommodated by the rollers 226, the slip clutch allows theses rollers to overrun the shaft so the paper is moved rapidly into the buffer. After the printed portion is ejected, movement stops so the knife 17 can cut a printed segment 24 from the paper in the printer (FIG. 23). The buffer drive motor 239 is turned off while the paper is held for cutting. After the segment 24 is cut from the paper supply, the drive motor 239 is turned on to drive rollers 226 of the buffer to move the segment through the buffer at a constant speed and deliver it to the downstream laminator 16 (FIG. 24). Meanwhile, the printer starts another printing operation.

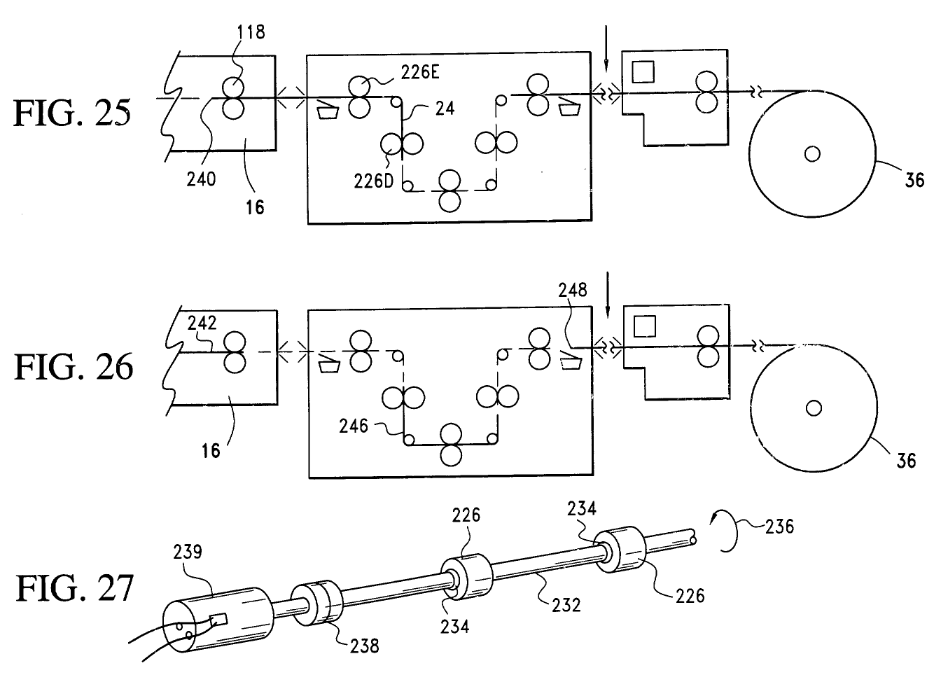

FIG. 25 shows the printed segment 24 entering the laminator 16. The leading edge 46 of the segment 24 enters the nip between laminator driven rollers 118 so the segment is pulled into the laminator. At this point, a trailing portion of the segment may still be in the grip of drive rollers 226 in the buffer. Accordingly, as the segment 24 is pulled into the laminator, the one-way clutches 234 associated with each roller 226 allows the segment to be pulled into the laminator at a speed faster than the transport speed through the buffer by allowing the segment to overrun the speed of shaft 232. Conversely, if the laminator operates slower than the buffer, the slip clutch 238 will prevent the buffer rollers from forcing the segment into the laminator.

FIG. 6 shows the segment 24 completely within the laminator as a subsequent and shorter segment 246 is being transported through the buffer and the leading edge 248 of yet another printed portion is entering the buffer.

Thus it should be appreciated that the present invention accomplishes its intended objects in providing a buffer for handing off a work piece from one device to another wherein the devices, such as an inkjet printer and a coater/laminator, that may have different processing speeds. The buffer located between the two devices defines a path of travel that preferably is longer than the longest work piece produced by a first device so that the work piece is never in the grips of both devices at the same time. This is especially significant where the work piece is segment comprising the printed output of an inkjet printer and the second or downstream device is a laminator for applying a protective coating to the printed segment. One-way clutches on the drive means for moving the work piece through the buffer accommodates the indexing motion of the inkjet printer and allows such indexing to occur at speeds higher than the transport speed through the buffer. The clutches also allow the downstream device, such as a coater/laminator, to pull a work piece, such as a printed output of an inkjet printer, from the buffer at a speed greater than the transport speed through the buffer.

Conversely, slip clutches in the buffer drive limit the force exerted on the work piece by the buffer drive rollers. This insures that an upstream device can stop the movement of the work piece to perform an operation on one portion of the work piece while another portion of the work piece is in the grip of the buffer.

In a preferred embodiment, the present invention provides a buffer between an ink jet printer and a laminating device wherein the laminator 16 may have a faster processing speed than the printer 12. The buffer 200 is adapted to receive the printed output of an inkjet printer 12 and deliver the output directly to a laminator 16 wherein the buffer 200 accommodates two processing speeds of the printer 12 and a single operating speed of the laminator 16.

First Service Loop

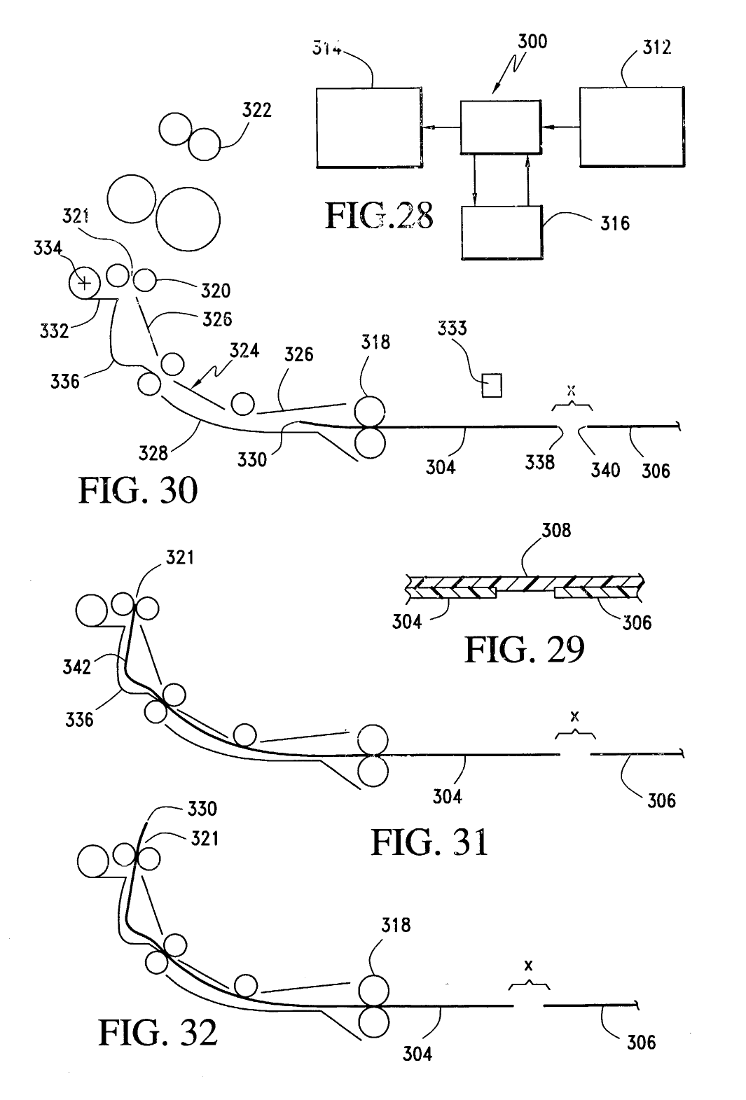

FIG. 28 shows a service loop 19 according to the present invention with the service loop generally indicated at 300, disposed between a first upstream workstation 312 and a second downstream workstation 314. The operation of the first service loop is under control of a controller 316 which could be same as controller 14 or a different controller as further described hereinbelow. The first service loop 300 as described herein is for use in a photofinishing operation wherein the first workstation is a laminator 16 and the second workstation is an embosser 20, all components being part of a photofinishing system 10. The laminator 16 and the embosser 20 are described above and below.

For efficient operation, the lamination material is drawn from a roll 114 and laid onto one or both surfaces of printed sheets individually fed to the laminator. To minimize waste of the lamination material, the gap or spacing between the individual printed sheets fed to the laminator is kept as small as possible. The result, as shown in FIG. 29 is a continuous piece comprising two adjacent printed sheets 304 and 306 connected by a layer of the laminate material 308. On leaving the laminator the continuous piece is cut between the adjacent printed sheets 304, 306 to again separate the individual printed sheets.

After the lamination is applied and the sheets are cut apart, the cut sheets are delivered to an embosser that puts a matte finish to the cut sheet. Generally the embosser operates at a faster speed than the laminator so one function of the first service loop is to receive cut sheets from the laminator (first workstation) operating at a first speed and deliver the cut sheets to the embosser (second workstation) operating at a faster speed. Another function of the first service loop is to insure that a cut sheet is completely free of the laminator before being delivered to the embosser. This is because damage can result to a cut sheet having one end in the grip of the laminator operating at one speed and another end in the grip of the embosser operating at a faster speed.

As shown in FIG. 30, the first service loop has a set of driven inlet rollers 318, a set of deskewing rollers 320 and a set of outlet rollers 322. The inlet rollers 16 are driven at the same operational speed as the laminator. The outlet rollers 322 are driven at the same operational speed as the embosser and the deskewing rollers are driven at a selected speed. Preferably, inlet rollers 318 are disposed at a lower elevation in the first service loop than the deskewing and outlet rollers.

A guide 324 composed of spaced upper and lower members 326, 328 respectively defines a path of travel between the inlet rollers and the nip 321 formed by the deskewing rollers. Since the deskewing rollers are disposed above the inlet rollers 318, the guide 324 defines a path of travel that curves upward to deskewing rollers 320 from the inlet rollers 318. Thus a cut sheet 304 passing from the laminator 16 and entering the first service loop through inlet rollers 318, has its leading edge 330 directed to the deskewing rollers 320.

The lower member 328 of the guide has an end 332 adjacent the deskewing rollers 320 fixed for rotation about an axis 334. Adjacent its end 332, the guide member 328 is formed with a dogleg 336 for purposes set out hereinbelow. Completing the structure is a sensor 333 that issues a signal to controller 316 upon the passage of the trailing edge of a cut sheet. The location of the sensor is such that passage of the trailing edge of a cut sheet signifies that the cut sheet is free of the grip of the laminator.

The operation of the first service loop will be described as beginning with FIG. 30, which shows the leading edge 330 of a laminated cut sheet 304 as passing between the drive rollers 318 and entering the first service loop. As noted hereinabove, drive rollers 318 operate at the same speed as the laminator. This insures that the portion of the cut sheet 304 in the grip of drive rollers 318 moves at the same speed as a trailing edge 338 of the cut sheet that may still be in the grip of the laminator. Also shown in FIG. 30 for purposes of illustration is a second cut sheet 6 that follows the first sheet and has its leading edge 340 spaced from the trailing edge 338 of the first sheet by a distance “x”.

The guide 324 leads the sheet 304 to the deskewing rollers 320. At this time the deskewing rollers are stopped. Eventually the leading edge 330 of the sheet contacts the nip 321 formed by the deskewing rollers while the drive rollers 318 continue to operate. This causes a portion 342 of the sheet adjacent the leading edge to buckle as shown in FIG. 31. The buckle is accommodated by the dogleg 336 in the lower portion of the guide. As the sheet buckles, the buckle takes up any skew of its leading edge relative to the nip 321 so that the leading edge becomes aligned with the nip. In this fashion a sheet that may be skewed upon entering the first service loop is deskewed by the first service loop and the leading edge is realigned parallel to the nip so that a properly orientated sheet is delivered to the embosser or downstream workstation.

After the deskewing operation is complete, the controller 316 momentarily activates the deskewing rollers 320 to allow the leading edge 330 and a small portion of the sheet to pass through nip 321 (FIG. 32). For this operation the deskewing rollers are driven at the same speed as the drive rollers 318. After the momentary activation, the deskewing rollers are stopped. In this fashion the nip of the deskewing rollers holds the sheet while the drive rollers continue to operate to move the cut sheet 4 into the first service loop at the same speed as the operational speed of the laminator. The deskewing rollers 320 are stopped while the drive rollers continue to operate to avoid a situation where a long cut sheet might extend into the outlet rollers 322 (that move at a faster speed) while part of the cut sheet is still in the grip of the drive rollers 318.

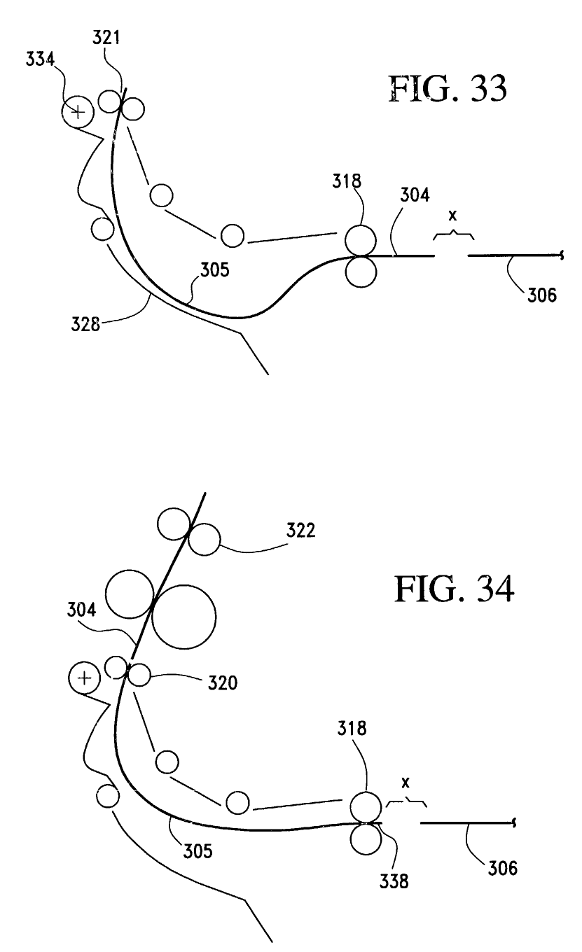

Since a length of a cut sheet may be longer than the length of the path of travel defined by guide 324, some room must be made for the length of sheet being moved into the first service loop while the deskewing rollers are stopped. Accordingly, the controller acts to rotate the lower portion 328 of the guide about the axis 334 so a trap in the guide is opened (FIG. 33). With the trap open, a length of the sheet driven into the first service loop can bow out into the space created by the opening. In this way the first service loop can accommodate a length of the sheet by causing a service loop 5 to form that is much longer than the length of the path of travel defined by the guide 28. The length of the service loop (L_{SL}) between the drive rollers 318 and the nip 321 equals the length of the path of travel with the trap closed (L_{C}) plus the speed (V_{L}) of the driving rollers 318 multiplied by the time that the deskewing rollers are stopped (T₁) or L_{SL}=L_{C}+(V_{L}×T₁).

At some point, the sensor 333 will identify the passing of the trailing edge 338 of the cut sheet signifying that the cut sheet is out of the laminator. When this occurs, controller 316 activates the deskewing roller for operation at a speed equal to the processing speed of the embosser or downstream workstation. This action takes up the slack provided by the service loop 305 and begins to move the cut sheet 304 through the driven outlet rollers 322 and into the embosser (FIG. 34). It is possible that the deskewing rollers can be activated to turn at the faster operating speed of the embosser before the trailing edge of the cut sheet is clear of the slower moving drive rollers. However, the controller insures that the slack provided by the service loop, that is the length of the service loop, contains a length sufficient to prevent the slack from being depleted prior to the time the trailing edge 338 of the first cut sheet clears the drive rollers. This avoids a situation where the cut sheet is put into tension between the drive rollers 318 operating at one speed and the deskewing rollers 320 operating at a faster speed.

As described above, the deskewing rollers draw the cut sheet from the service loop at a speed faster than the speed at which the following sheet 6 is delivered to the first service loop. However, the length of the first sheet may be such that time does not permit the removal of a sufficient length of the first sheet 4 to prevent the following sheet 306 from catching up to the first sheet at some point along the path of travel. In other words the length of the gap “x” between the sheets could be reduced to a negative number before the first sheet is out of the first service loop. This means that the leading edge 340 of the second or following sheet 6 will run into the trailing edge 338 of the first or leading sheet 304. Keeping the trap open avoids this situation.

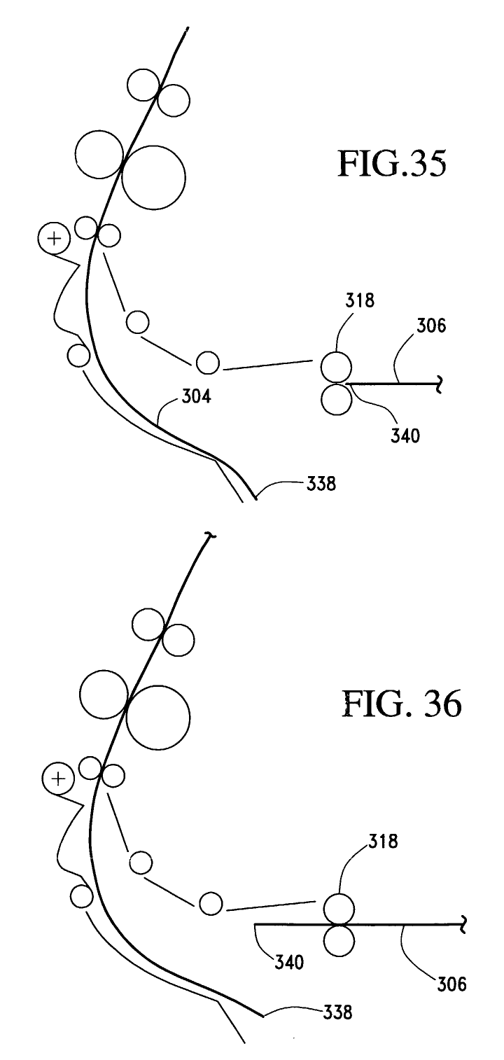

As shown in FIG. 35, the trailing edge 338 of the first sheet 304 as it clears the drive rollers 318 will drop from the drive rollers and leave the defined path of travel. This is because the location of the deskewing rollers at a higher elevation than the drive rollers 318 and the curvature of the path of travel cause the trailing edge 338 of the cut sheet to spring downwards and away from the drive rollers. Now when the leading edge 340 of the following sheet passes through the nip at the drive rollers 318, it will be vertically displaced from the trailing edge of the first sheet as shown in FIG. 36. This displacement avoids an overlap that could cause the two sheets to contact.

If the length of the leading sheet 304 is such that no over lap is created with the leading edge of the following sheet, the trap can be closed. Conversely, if the length of the first sheet is such that there is an overlap with the following sheet, the trap will remain open to allow time for the first sheet to “run away” from the following sheet before the trap is closed. The over lap can be calculated using the following formula:

Overlap=(L_{R}−L_{C})−(x)(V_{E})/V_{L}

Where L_{R}=length of service loop when the trailing edge of the first sheet leaves the laminator

L_{C}=the length of the path of travel with the trap closed

“x”=length of the initial gap between the sheets

V_{E}=the speed of the embosser and

V_{L}=the speed of the laminator.

If the overlap is calculated to be a negative number, there is no over lap and the trap can close as soon as the length of the service loop is less than the length of the path of travel with the trap closed. If the calculation yields a positive number, the sheets would overlap so the trap must remain open and allow the first sheet to move away from the following sheet.

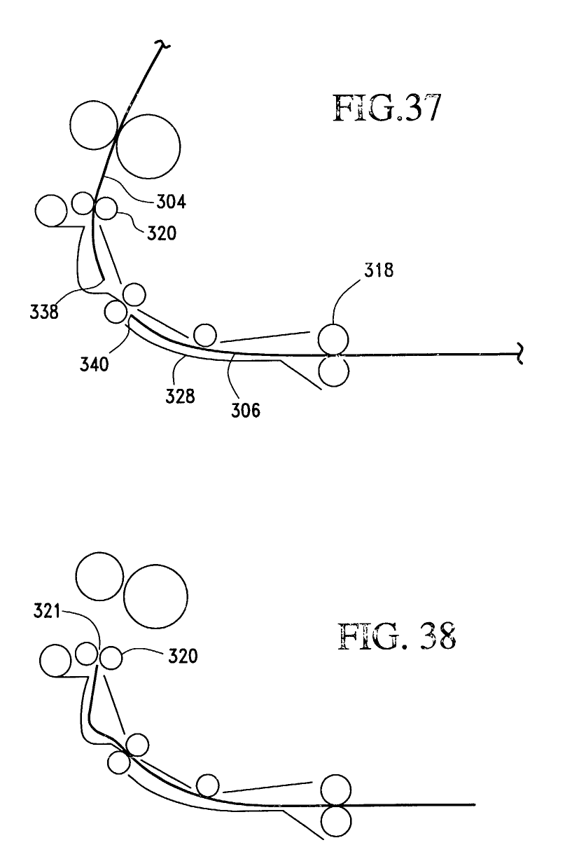

After a time, there is a removal of the first sheet by the deskewing rollers 320 sufficient to reestablish a gap between the two sheets. Then the controller causes the lower guide portion 328 to close as shown in FIG. 37. This reestablishes the path of travel for guiding the leading edge 340 of the second sheet 306 to the deskewing rollers 320. After passage of the first sheet from the first service loop, these rollers are stopped and the action repeated to deskew the following sheet 306 as shown in FIG. 38.

Thus it should be appreciated that the present invention provides a first service loop disposed between workstations that have different operational speeds that can accommodate a cut sheet entering at one operational speed and then pass it out of the first service loop at a second operational speed. The first service loop further is able to stop and deskew a sheet while preventing a trailing sheet from running into a leading sheet. The first service loop is able to accommodate sheets of various lengths including sheets longer than a path of travel through the first service loop.

Embosser

Referring to the drawings, FIG. 39 shows generally the sequence of steps for producing an inkjet printed photograph. In this respect the photofinishing system 10 includes the inkjet printer 12. The printer is fed from the continuous roll of photographic paper 36 that preferably is a conventional paper used in inkjet printing to produce glossy photographs. A controller such as a computer 14 that has been loaded with a digital representation of the image or images to be printed controls the printer. The printed output passes from the inkjet printer 12 and into a coater/laminator 16. The printer and laminator generally have different operational speeds so a buffer 18 is disposed between the two. The buffer 18 serves to operatively connect the printer to the laminator by first accommodating the output from the printer and then handing the printer output off to the laminator.

In the laminator, a protective laminate is applied to the printed surface of the photographic paper. The laminate is any suitable clear plastic 0.5 to 1.0 mil film that is applied to the printed surface of the paper. The paper and laminate then pass through a nip 118 (shown in FIG. 10) that presses the two together, preferably with heat so the laminate is adhered to the image surface. Since the photograph is on glossy paper and both surfaces of the laminate are smooth, the result is a laminated, glossy finish photograph.

From the coater/laminator, the laminated structure passes into an embosser 20. While not shown, there may be a buffer between the laminator 16 and the embosser 20 in cases where the two have different operational speeds. The embosser is selectively operated either to produce a glossy finish photograph or a photograph having a matte finish. Information as to whether to produce either finish of photograph is inputted to the computer 14. The computer then controls the embosser as set out hereinbelow to produce the desired finish.

As shown in FIG. 40, the embosser 20 has an inlet 424 for receiving the laminated glossy finish print output 42 of the laminator. The print 42 includes a section of the photographic paper 24 including the inkjet-printed image and a section of laminate 132 disposed over the printed image and affixed to the paper. The inlet of the embosser connects to a guide track 428. The guide track and pairs of spaced drive rollers 430, 432 define a path of travel (indicated by a dotted line) through the embosser to an exit 434. Other drive rollers 436 may be located adjacent the track to facilitate the transport of a laminated photograph from the embosser inlet 424 to the exit 434. The spacing between pairs of drive rollers is small enough to accommodate the shortest photographic print delivered to the embosser.

Arranged along the path of travel and preferably between the roller pairs 430 and 432 is an embossing mechanism generally indicated at 438. The embossing mechanism includes an embossing roller 440 located at one side of the path of travel. The roller or at least the outer surface 442 of the roller is made of metal or other material that can be heated and retains heat. Preferably the embossing roller is hollow and has a heating element 444 disposed in the hollow for heating the roller and more particularly, for heating the outer surface 442. Any suitable heating device can be used including resistance or radiant heaters. Preferably the heater is a heating lamp incorporated into the embosser roller. A motor (not shown) drives the embossing roller.

The outer surface 442 of the embossing roller is textured by any suitable means such as by chemical etching or mechanical operation that will provide the roller with a degree of roughness. The roughness preferably is greater than 100 micro inches and sufficient, given various factors as set out hereinbelow, to provide the print out put 26 of the laminator with a matte finish. The texture of the outer surface should be as random as possible with no sharp points.

Located across the path of travel opposite the embossing roller is a pressure roller 446 having a resilient outer surface formed of a rubber or the like. The pressure roller is journaled to a lever arm 48. The lever arm has a pivotally supported end 450 and a free end 452 wherein the pressure roller is journaled to the arm intermediate the supported and free ends 450, 452 respectively. The lever arm is biased by a spring 454 or the like that urges the free end of the arm about its pivoted end 450 to the left or to a first position as viewed in FIG. 40.

This creates a space 456 between the pressure roll 446 and the embossing roller 440 so as to maintain an open path of travel. It also maintains contact of the free end 452 of the lever arm with a mechanical cam 458. The cam is selectively operated to drive the lever arm free end 452 to the right and to a second position as viewed in FIG. 41. This closes the space 456 and causes the pressure roll 446 to bear against and form a nip with the embossing roller 440. Operation of the cam is under the control of the computer 14 so that the selective actuation of the cam to allow movement of the pressure roller between its first and second positions determines whether a glossy or matte finish photograph is produced as further set out hereinbelow.

The operation of the embosser 20 begins by heating the embossing roller 440. A proper operating temperature may vary depending upon the material of the laminate, the roughness of the surface 442 of the embossing roller and the pressure exerted at by the pressure roller. In any event when temperature is reached, the embosser is in condition to receive an image from the coater/laminator 16. Accordingly, as shown in FIG. 40, the laminated glossy finish photograph 42 oriented with its laminated side positioned on the same side of the path of travel as the textured embossing roller 440, enters the inlet 424. The photograph is moved forward through a series of driven rollers, such as shown at 436, 430 along the path of travel toward the embossing roller 440.

If a glossy finish photograph is desired, the path of travel is kept open by maintaining the pressure roller in the position as shown in FIG. 40. This keeps the path of travel open so the laminated glossy finish photograph is transported through the space 456 without contacting the embossing roller. In this fashion the glossy finish is not disturbed as the laminated glossy finish photograph passes through the exit 434. Consequently, a glossy finish photograph moves through the embosser exit 434

If a matte finish photograph is desired, the computer 16 causes the operation of cam 58. Operation of the cam causes the lever arm 48 to pivot to the right as shown in FIG. 40, which in turn causes the pressure roll 46 to create a nip between it and the heated embossing roller 40. Now, when a laminated print reaches the embossing roller, the print passes through the nip so the laminate side 15 is contacted and pressed against the heated embossing roller. The heat of the embossing roller softens the laminate 15 and this allows the textured surface of the embossing roller to modify the surface of the laminate by embossing the texture of the roller surface 42 into the laminate. The result of this operation is that light now will reflect off the laminate surface at a different rate giving it the appearance of a matte finish. The photograph passes to the exit 434 and a matte finish photograph is produced from the glossy print.

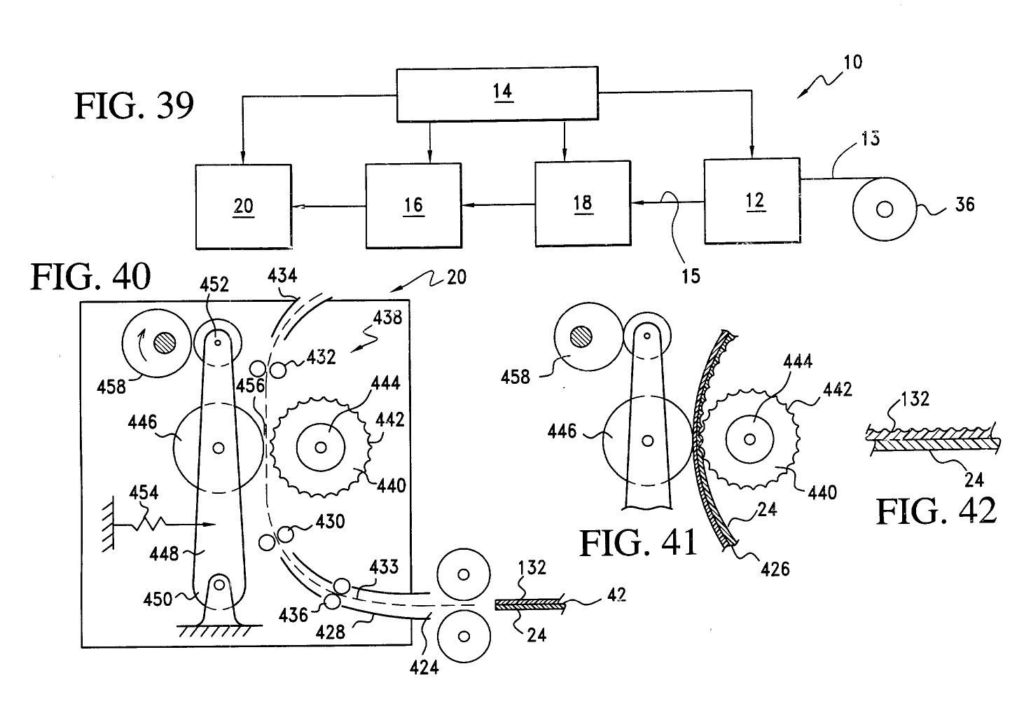

The resulting matte finish photograph is shown in FIG. 42. As shown in FIG. 42, the glossy paper substrate 24 is overlaid with the laminate 132 and the laminate has its outer surface embossed. This provides the photograph with a matte finish wherein the matte finish is applied in situ to the photograph as opposed to an initial printing of the photograph on a matte finish paper.

It is generally understood that a glossy image is one that generates values of between 60 and 70 on a 20° reflectivity scale. In contrast, an image having a matte finish is one considered to have reflectivity values generally below about 40 and preferably below about 10-26.

As noted above the various factors of temperature, pressure, the finish of the embossing surface and the particular material and thickness of the laminate are factors contributing to the production of a matte finish. For conventional plastic films used as photographic laminates as described herein, a temperature of the textured surface above 75° C. is too extreme as at this temperature, the laminate tends to delaminate from the print rather than be embossed. Conversely, a surface temperature of below about 50° C. appears to be too cold to accept texturing form the roller. Accordingly a temperature range of between 50° C. and 75° C. is considered an operable range.

The pressure at the nip and surface roughness of the embosser roller also are related in that the amount of force pressing on the laminated surface is directly proportional to the surface roughness of the embosser roll. Given the operational factors of the particular material used as the laminate, an acceptable range of parameters for the degree of surface roughness, the temperature of the embossing roll and the pressure applied are matters of design within the skill of the art.

Accordingly, it should be appreciated that the present invention accomplishes its intended objects in providing a method and apparatus for producing either a glossy finish or a matte finish photograph from the same glossy print stock. The apparatus allows the photofinishing operator to selectively make either glossy or matte prints without the need to inventory both glossy and matte finish print paper. Print Cutter

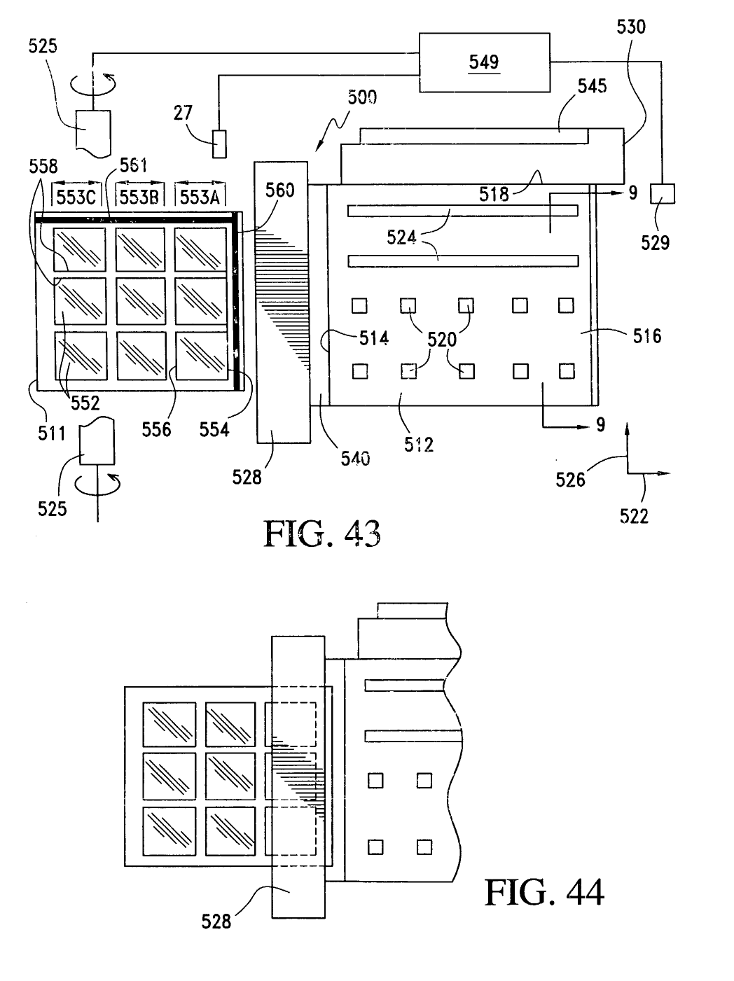

Referring to the drawings, FIGS. 43-48 shows a sequence of steps for severing individual prints from a sheet 511 containing a plurality of prints. In this respect the cutter and transporter of the present invention, portions of which is indicated at 500, includes a transport table 512. The table has an inlet end 514 at one side, an opposite end 516 and an exit end 518 disposed at the rear of the table orthogonally with respect to the inlet end. While not limited to size, an embodiment of the invention has a table that is of a size able to accommodate a web width of about 28 to 32 cm and a full web length of up to about 51 cm.

Incorporated into the transport table 512 is a driver system for moving a sheet first longitudinally from the inlet end 514 to the opposite end 16 and then transversely along the opposite end 516 to the table exit 518. Portions of the driver system as shown in FIG. 43 include a plurality of longitudinally spaced driven rollers 520. The rollers preferably are arranged in pairs and are disposed for moving a sheet along the table in a longitudinal path of travel indicated by arrow 522 that extends from the inlet end 514 and towards the opposite end 516. These rollers 520 extend through openings in the table and are grouped generally towards the front of the table as viewed in FIG. 43.

A second set of driven rollers 524, also extending through openings in the table, are arranged for moving a sheet along a second path of travel indicated by arrow 526 that is perpendicular to the first path. The second path of travel is in a transverse direction and towards the table exit 518.

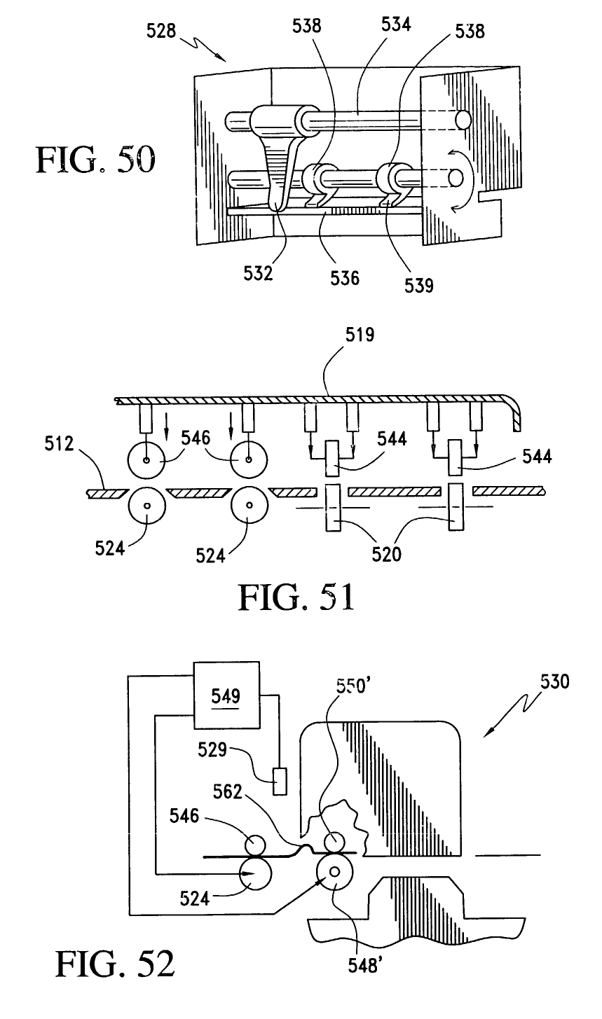

As best seen in FIG. 51, housing 519 is disposed over the table (the housing being removed from FIGS. 43-48 for viewing the table). Supported within the housing are first and second sets of idler pinch rollers 544, 546 respectively. The set of idler pinch rollers 544 is arranged for movement so as to create a nip with the driven rollers 520. Forming the nip acts to drive a sheet caught in the nip in a longitudinal direction across the transport table (in the direction of arrow 522 in FIG. 43). The second set of idler pinch rollers 546 is arranged for movement so as to create a nip with the driven rollers 524. This acts to drive a sheet caught in the nip in a transverse direction across the table and towards the exit 518 in the direction of arrow 526 (FIG. 43). The two sets of idler rollers 544, 546 are independently controlled so that there is selected movement in both the longitudinal and transverse directions.

Disposed adjacent both the table inlet and outlet ends 514, 18 are cutter mechanisms 528, 530 respectively. Located in advance of cutter 528 is a sensor 527 such as an LED emitter-detector. A similar sensor 529 is located in advance of cutter 530 (FIG. 43). Both sensors 527, 529 are connected to a controller 549 for purposes set out hereinbelow. This could be the same as the controller 14 or a different controller. The cutter mechanisms 528, 530 have substantially the same construction so only cutter mechanism 528 is described in detail. As seen in FIGS. 49, and 50, cutter mechanism 528 at the inlet end includes a rotary knife 532 that is supported on a mandrel 534 extending perpendicular to the first path of travel 522. The knife is movable along the mandrel and against an anvil 536 for shearing off a piece of the sheet 511. Preceding the knife along the path of travel is a set of paper clamps 538.

Clamps 538 are mounted for pivotal movement between open and a closed position. Each clamp includes a foot portion 539 that in the closed position (as shown in the FIGS. 43-51) bear against the anvil 536. In the closed position the feet 539 operate to apply a force for holding the sheet 511 against the anvil 536 and in position during a cutting operation. Following the knife along the path of travel is a waste collector generally indicated at 540 (a similar waste collector 556 being associated with cutter 30). The waste collector is arranged to receive any portion of the sheet that is removed by the cutter mechanism. In this respect the waste collector is disposed generally below the anvil 536 and includes a pair of counter rotating augers 541. These augers insure that any piece cut from the sheet by the rotating knife 532 is drawn downwards through an opening 542 and into a waste receptacle 543.

To complete the construction, each cutter mechanism includes a registration roller 548 that nips with a pinch roller 550 for delivering a sheet 511 to the cutter as described hereinbelow. Preferably, a stepper motor (not shown) drives the registration roller. The stepper motor for driving the registration roller 548 is controlled in part by a controller 549 that receives input from sensors 527 and 529.

Operation will be described with reference to FIGS. 43 and 49 as beginning with a sheet 511 being delivered to the cutter mechanism. The sheet contains a plurality of individual photographic prints 552 applied by an ink jet printer or the like. As shown in FIG. 43, the sheet measures about 33×50.8 cm and contains an array of nine individual prints each measuring about 10.16×15.24 cm. The prints are arranged in an array that contains rows 553A, B and C extending across the sheet and columns extending along the sheet. The prints in each row have aligned leading and trailing edges 554, 556 respectively and the prints in each column have aligned lateral edges 558.

It should be appreciated that while nine similar size prints are shown, prints of various sizes can be arranged on the sheet so long as the prints in each row have one dimension (either length or width) in common so as to present aligned leading and trailing edges 554, 556. The second dimension (length or width) of the prints in each row can vary. If all the prints are of equal size as shown, the columns will have aligned lateral edges 558. However, each row can contain images of various sizes and where the prints do not have a second dimension in common the lateral edges 558 will not be aligned. For example, given a sheet 511 that is thirteen inches wide, a first row 553A may be printed with two 4×6 images; or a 4×6 image and two 4×3 images; or a 4×9 image and a 4×3 image. A next row 553B might contain two 5×7 images; or a single 8×10 or 5×12 image. It only is important that the images in each row have one dimension in common and that the sum of the second dimensions plus the trim waste does not exceed the width of sheet 511.

Preferably each image is slightly oversize to allow for a non-precision cut location. Also, the array of prints on the sheet is surrounded by a fiducial mark. A first fiducial mark 560 comprises a dark transverse stripe located in advance of the leading edge 554 of the first row 553A of prints. This fiducial mark provides for the detection of the first row of prints entering the transport table inlet end 514. A second fiducial mark 561 comprising a dark longitudinal stripe extends the length of the sheet 511 adjacent at least one side of the sheet, preferably the side towards the rear of the transport table. The fiducial mark 561 lies between the sheet edge and the lateral edge 558 of the column of prints adjacent this sheet edge.

The sheet is delivered to the cutter mechanism 528 by a carrier, a portion of which is shown at 525 that is operated by the controller 549 (FIG. 43). It should be noted that as part of the operation for printing the images on the sheet, the controller is provided with a memory of the print layout. This memory, for example, includes information as to the distance between the leading and trailing edges 554, 556 of each row 553A, B and C as well as the length in the transverse direction of each print in each row.

As the sheet approaches the cutter, the sensor 527 first detects the leading edge of the sheet and then the fiducial mark 560. The distance between the sheet leading edge and the fiducial mark is communicated to the controller. The carrier 525, continuing its operation, delivers the sheet to the nip between the registration roller 548 and pinch roller 550. When the leading edge of the sheet butts the nip at the registration roller 548, the carrier 525 is slightly overdriven. This creates a slight buckle near the leading edge to insure that it is seated properly in the nip.

The registration roller then is driven, preferably by a stepper motor (not shown) under the control of controller 549 to draw the sheet 511 into cutter mechanism 528. Since the distance between the leading edge of the sheet and the fiducial mark 560 has been communicated to the controller 549, the stepper motor is operated by the controller to drive the registration roller 548 and advance the sheet into the cutter to a first cut position (FIG. 44). At the first cut position, the leading edge of the first row 553A of prints is disposed at the edge of the anvil and below the knife 532. The clamps 538 then are pivoted to a closed position, which clamps the sheet to the anvil. After clamping, the knife 32 is drawn along the support mandrel 534 to make an initial cut.

The initial cut removes a strip from the sheet including the fiducial mark 560 and a small portion of the over printing to the trailing side of the fiducial mark. The cut off strip drops into the waste collector 540 aided by augers 562 (FIG. 49) that pull the waste through the opening 542 and into the receptacle 43.

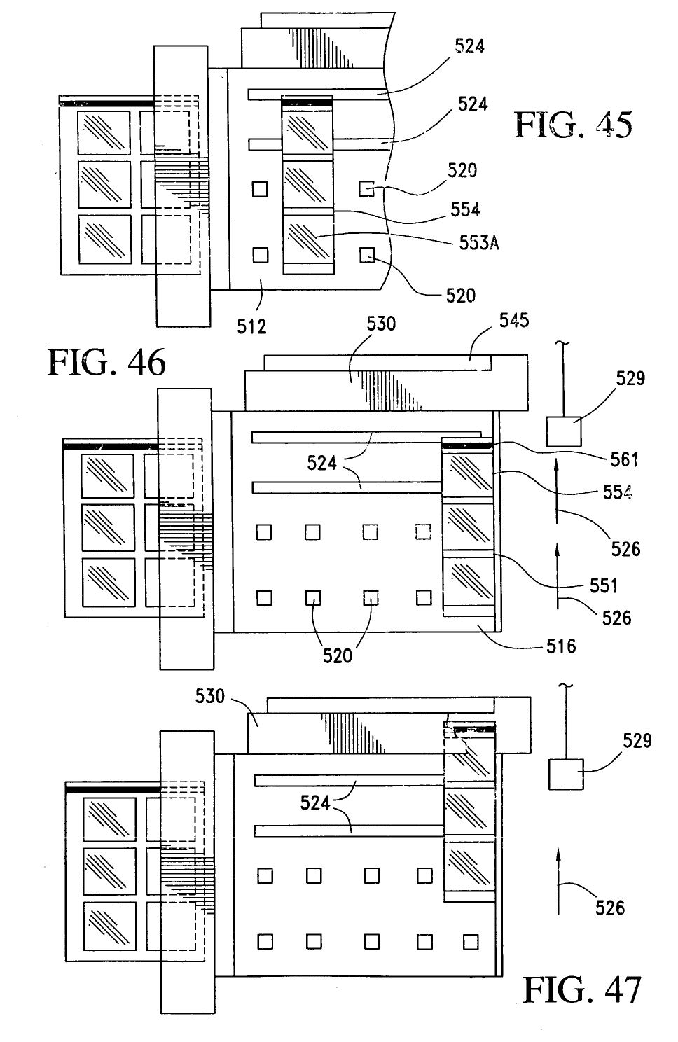

After the initial cut is made, the clamps are pivoted to an open position to release the sheet. The stepper motor for driving the registration roller is again activated. The controller 549 next causes the registration roller to draw the sheet to a position for making a second cut and stops. As noted above, the length of the first row 553A (distance between leading edge 554 and trailing edge 556) is a known dimension. Accordingly the registration roller 548 is operated by the stepper motor under the control of the controller 549 so as to index the sheet a distance sufficient to locate the trailing edge of the first row at the cutting location. The clamps 538 again are pivoted into a clamping position to hold the sheet for the second cut. The second cut is performed as before. In making the second cut, the knife cuts into the overprinted area at the trailing edge of the row so the first row 553A of prints is severed from the sheet. At this point the registration roller operates to move the strip comprising the first row of prints 553A onto the cutter transport table 512 (FIG. 45).

As the strip is moved onto the cutter table 512, the idler rollers 544 are lowered and the driven rollers 520 (also under the control of controller 549) are powered for moving the strip longitudinally across the transport table to the opposite end 516 (FIG. 46). The translation longitudinally across the transport table stops when the strip contacts a stop 551 at the opposite end 516 or a sensor (not shown) detects the leading edge 554 of the strip (FIG. 45). Either event triggers the lifting of the longitudinal idler rollers 544 and stops the rotation of the driven rollers 520.

The lateral idler pinch rollers 546 (FIG. 51) then are lowered to press against the strip and power is applied to the driven lateral rollers 524 to move the strip in a transverse direction across the transport table as shown by arrow 526 and into the cutter 530 (FIG. 46). As the strip approaches the cutter 530, the sensor 529 first detects the lateral edge of the sheet and then the fiducial mark 561. The distance between the lateral edge and the fiducial mark is communicated to the controller 549. The lateral rollers 524_continue to move the strip into the cutter until the edge is driven into the registration nip between the registration roller 548′ and the pinch roller 550′ in cutter 530 (FIG. 52). At this point the registration roller is stationary and the lateral drive rollers 524 are over driven to create a small buckle or loop 562 in the strip as shown in FIG. 52.

Overdriving the lateral roller 524 to create the buckle insures that the edge of the strip is well referenced to the registration roller 548′ and insures a proper orthogonal orientation of the strip prior to being drawn into the cutter. After the buckle is created, the lateral roller 524 is stopped and the registration roller 548′ is activated. The idler pinch rollers 546 are kept in contact with the driven roller 524 until after the edge of the strip has been pulled in to the nip with the registration roller 548′. This insures no loss of location. The pinch idler rollers 546 are then released so the registration roller 548′ can draw the strip into the cutter.

Since the distance between the edge of the strip and the fiducial mark 561 is known, the registration roller 548′ can be operated to position the strip at the appropriate cutting position. Clamps in the cutter 530 similar to clamps 538 are pivoted to a closed position to clamp the strip at the cutting position. A first cut that includes a portion of the over printing then is made and the leading edge waste is drawn into a waste collector 564 adjacent the transport table outlet end 518.

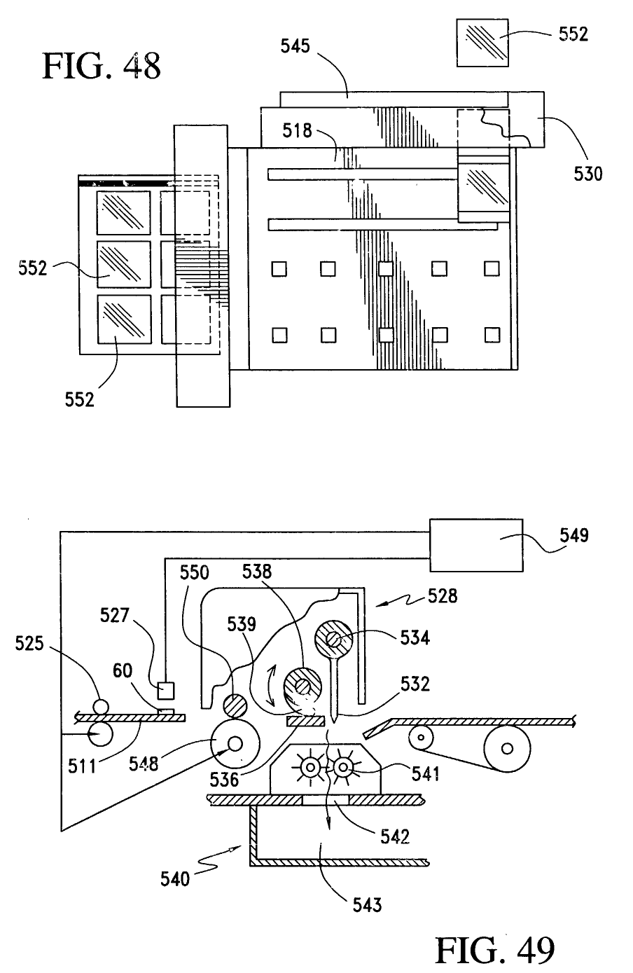

The registration roller in cutter 530 is again activated to advance the strip farther into the cutter mechanism 530 by a distance sufficient to locate the trailing edge of the image at a cutting location. Since the width of the print is known, the registration roller within the cutter 530 under the control of a stepper motor (not shown) can advance the strip so as to position the trailing edge of the print for a second cut. Making the second cut separates a first print in the row and the print, now cut to size, is delivered to a print stacker (not shown) at the outlet end 518 of the transport table 512 (FIG. 48).

Additional lateral advances and cuts are made until all of the photographic images in the first row 553A are separated and trimmed to size. The next cycle then begins with the longitudinal advance of the next row 553B of prints into the cutter 528.

Accordingly, it should be appreciated that the present invention accomplishes its intended objects in providing a method and apparatus for cutting prints of various sizes from a larger sheet. The apparatus provides for the movement of a sheet of prints along orthogonal paths of travel so that the proper cuts can be made to sever prints of various widths from a larger sheet. The transport table 512 includes roller arrangements that are selectively engaged for moving a sheet in two directions across the transport table. Cutter mechanisms adjacent the inlet and out let end of the transport table include means that cooperate with fiducial marks on the sheet of prints. The cooperation provides for locating the sheet at the proper cutting locations first for severing a strip of photos from the sheet and then severing individual photos from the strip.

Second Service Loop

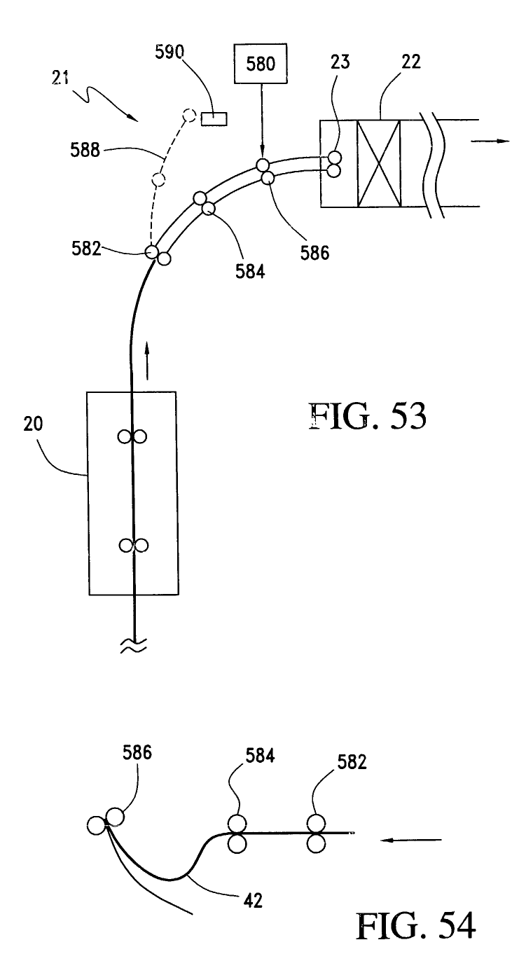

Referring to the drawings, FIG. 53 shows a second cutter service loop 21 according to the present invention generally indicated at 21 disposed between a first upstream workstation, in this embodiment, the embosser 20 and a second downstream workstation, in this embodiment the cutter 23. The operation of the second service loop 21 is under control of a controller 580 which could be the same as controller 14 or a different controller.

As shown in FIG. 53, the second service loop 21 has a set of driven inlet rollers 582, a set of deskewing rollers 584 and a set of outlet rollers 586. The inlet rollers 582 are driven at the same operational speed as the embosser. The outlet rollers 586 are driven at the same operational speed as the cutter and the deskewing rollers are driven at a selected speed. Preferably, inlet rollers 582 are disposed at a lower elevation in the first service loop than the deskewing and outlet rollers. This is accomplished with the help of a bridge 588 driven up by a motor 590.

The bridge 588 provides a well defined path until the transition occurs and the loop forms, then the constraint is removed. The bridge 588 allows the paper loop to form as shown in FIG. 54. The operation of the second service loop 21 as the paper loop forms is similar to that discussed above in reference to the first service loop 19. The second service loop 21 also alleviates problems due to differential speeds and or paper lengths as discussed above in regard to the first service loop 19. Under normal operations the digital film processor 10 could be running the embosser at 0.3 inches per second and the cutter at 0 to 5 inches per second since the cutter has to stop, cut and start up again. The second service loop 21 allows the digital film processor 10 to accommodate the different operational speeds of the various components, especially that of the embosser and the cutter.

It is important when operating the second service loop 21, that the bridge 588 not be opened too soon. The bridge timing and placement are important to allow the digital processor 10 to operate efficiently. The second service loop 21 also helps prevent misalignment of the paper. The bridge is designed to support the whole paper path when it is in place. The bridge shape preferably emulates that of the paper path, such as the shape of a complete arc. There is an alternate embodiment in which the bridge shape is a bi-modal one made up of two or more arc pieces.

Backside Printer

The backside printer 34, as shown in FIG. 2, takes the prints 29 and prints fiducial marks on the backside of the prints 29 to help identify the source, date, or other relevant information.

Conveyor and Stacker

The conveyor and stacker 35, as shown in FIG. 2, work together to convey the prints 29 and stack them for distribution.

Accordingly, it should be appreciated that the present invention accomplishes its intended objects in providing a photofinishing method and apparatus that utilizes otherwise wasted space resulting from the nesting of images on a print media.

It should be appreciated that the present invention is not limited to photofinishing but has application in any instance where a quantity of a product is requested by a customer and the products are made from a resource of a given size. For example, a customer order may involve the stamping of a given number of units from a roll of sheet metal. If the arrangement of the units on the roll result in an amount of the sheet being wasted, the customer can be offered one or more additional units at a reduced cost to recoup the cost of the otherwise wasted sheet metal.

Having described the invention in detail, what is claimed as new is:

1. Apparatus for high volume, low cost photo finishing comprising:
an inkjet printer having a printing width greater than twice the width of a first print size, and at least equal to the width of a second larger print size;
a supply of continuous feed media;
an image processor connected to the inkjet printer for digitizing images to be printed and arranging the digitized images for printing in at least a 2×2 matrix of prints of at least two different sizes;
a cutter for cutting the continuous feed media into sheets, each sheet carrying the matrix of prints; and
a two-axis cutter controlled by the image processor and cutting the sheets into individual prints of at least two different sizes.

2. The apparatus of claim 1 comprising a laminator disposed between the inkjet printer and the two-axis cutter for laminating the sheets with a protective film of material.

3. The apparatus of claim 1 in which each matrix of prints comprises prints for a single customer.

4. The apparatus of claim 2 comprising a buffer between the printer and the laminator.

5. The apparatus of claim 1 in which the inkjet printer comprises a marking engine and a dryer.

6. The apparatus of claim 1 in which the supply of continuous feed media comprises a roll of media.

7. The apparatus of claim 6 in which the roll of media comprises a roll of paper.

8. The apparatus of claim 2 in which the laminator comprises an embosser coupled to the image processor for selectively embossing the prints to simulate a matte finish.

9. The apparatus of claim 1 comprising a waste receptical coupled with the two axis cutter for receiving strips cut from the sheet.

10. The apparatus of claim 1 in which the two axis cutter comprises an input cutter arranged on a first edge of the two axis cutter and an output cutter arranged on a second edge of the two axis cutter orthogonal to the first edge.

11. The apparatus of claim 1 in which the cutter cuts the media into sheets having lengths that vary over a range of at least 2:1.

12. The apparatus of claim 3 comprising a sorter coupled to the image processor and the two axis cutter and sorting the individual prints by customer.

13. The apparatus of claim 1 comprising a stacker coupled to the image processor and the sorter stacking the prints by customer.

14. The apparatus of claim 1 comprising a backside printer coupled to the image processor and disposed between the two axis cutter and the sorter.
